(19) United States
(12) Patent Application Publication
(10) Pub. No.: US 2008/0162267 A1
(43) Pub. Date: Jul. 3, 2008

(54) Apparatus and Method of Collaborative Funding of New Products and/or Services

(75) Inventor: Larry Wolf, Santa Fe, NM (US)

Correspondence Address: BINGHAM MCCUTCHEN LLP, Three Embarcadero Center, San Francisco, CA, 94111-4067, US

(73) Assignee: NONZERO LLC, Santa Fe, NM (US)

(21) Appl. No.: 11/932,600

(22) Filed: Oct. 31, 2007

Related U.S. Application Data
(62) Division of application No. 09/947,583, filed on Sep. 6, 2001.

(51) Int. Cl. G06Q 40/00; G06Q 30/00

(52) U.S. Cl. 705/10; 705/35

(57) ABSTRACT

This invention is a Collaborative Funding Engine (the Engine) that accurately predicts initial demand for and facilitates the funding of design, research, development and/or delivery of products, and/or services (Outputs). The Engine enables one or a plurality of those (the Customers) who desire specific Outputs to combine their resources in Collaborative Funding Pools (CFPs) to fund the Outputs by an Output producer (the Provider) prior to the Output's creation. The Engine includes a Contingent Purchase Order (CPO) system that creates binding obligations on Providers and Customers contingent upon the CFP reaching a specified level (the Hurdle Level) of participation by Customers. The Engine includes an optional Relative Value Bidding feature that can allow each Customer in a CFP to determine its own price for an Output. As a result, different Customers can pay different prices for the same Output depending upon the Output's relative value to the Customer. The collaborative activity of the Engine is stimulated by its Notification Management Module, which informs Providers and Customers of activity within the Engine.

### BACKGROUND OF THE INVENTION

1. Field of the Invention

This invention generally relates to a new method of and apparatus for accurately predicting initial demand for new design, research, development, and/or delivery of products and/or services (Outputs) and fully or partially funding these Outputs in advance of their creation. Specifically, the invention, the Collaborative Funding Engine (the Engine), provides a method and apparatus for pre-selling the Output to a pool of substantially independent participating purchasers (Customers) who are willing to make binding commitments to purchase the Output prior to its creation.

2. Background

Modern capitalist economies are governed by an impersonal, Darwinian efficiency. Products and services that are accepted by the marketplace survive. Those that are rejected by customers either because the specifications or the price are unacceptable die and disappear. Business is inherently risky. The marketplace is efficient. Demand and price are the principal market features that determine whether a specific product or service is supplied and whether it is successful.

From another perspective, however, our modern capitalist economies are very wasteful and inefficient because of the inherent difficulty of accurately predicting market demand and setting a profitable market-clearing price for a given supply. The business landscape is littered with failed companies and failed products where either Customer demand or a market clearing price were poorly projected. The cost of capital and labor that is wasted on the development and delivery of products and services that are rejected by the marketplace is enormous. This cost gets built into, or recouped by, the price of the products and services that survive. So, we pay more for the things we want than is necessary. At the same time, economic growth and quality of life are suppressed because the risk of failure suppresses the development and delivery of many products and services that are in demand. A more predictable and dependable method is needed to efficiently match supply and demand in advance of new product or service creation.

Well-established at-risk practices exist through which enterprises raise funds from investors, lenders, or internal cash flow to finance the research, development, and delivery of new goods and services. Equity investments dilute the current ownership of the enterprise, and interest on borrowed funds or diverted internal cash flow tax the financial strength of the enterprise. And, none of these approaches to funding new product or service development leaves any assurance that the new product or service will be accepted by the market.

No method exists today that enables a Provider to raise resources to fund new design, product, or service research, development and/or delivery from the Provider's current or potential customers.

Furthermore, no method exists today that enables and encourages customers purchasing the identical product or service under identical terms and conditions to publicly and legally agree to pay different prices based on the relative value of the product or service to the individual participating customers. The absence of this customer-determined flexible pricing mechanism forces Providers to name a single price for an Output under given terms and conditions. The difficulty of accurately determining a single market-clearing price blocks the development of many new products and services. The failure to successfully select a successful market-clearing price leads to the failure of many new products and services that are developed and launched.

A method that can (1) efficiently and effectively gauge the initial demand for a proposed new Output and (2) fully or partially fund the proposed new Output by enabling and encouraging Customers to commit to binding purchase orders for this proposed new Output prior to the Provider allocating funds to design, develop, or produce the Output would achieve the following:
a) Greatly reduce the risk to Providers of launching new products and services,
b) Substantially reduce the cost to Providers of new product and service failures,
c) Thereby, substantially reducing the price to Customers of new product and services, and
d) Encourage Providers to bring to market new products and services desired by Customers but currently considered by Providers to be too risky to develop, thus enabling Customers to receive functional benefits that are not provided by currently existing market mechanisms.

### PRIOR ART

### Business and Government Agency Collaborations

Occasionally, a group of government agencies or business enterprises will collaborate. The Army and the Marines may agree, for example, to jointly engage a manufacturer to develop and produce a new combat tank. IBM and Apple Computer may jointly hire Motorola to develop a new micro-processing chip. The leading cell phone manufacturers may come together to develop universal standards for communication protocols.

Importantly, there are innumerable opportunities in modern economies for a collaboration of enterprises to combine resources to create a new Output that no one party in the collaboration could readily afford to finance individually. Yet, there are so few business collaborations attempted that their formations are typically headline business news. Why is collaborative design, research, development, and/or delivery so seldom employed? Answer: a mechanism to efficiently build viable collaborations does not currently exist.

Creating a collaboration of parties in the manner in which such business and government agency collaborations are currently created is a cumbersome, complex, and labor-intensive project. Creating such a collaboration requires extensive conversations and negotiations before participating parties are willing to commit to the collaboration. Commercial enterprises are especially wary of collaborating with competitors. Because of this, typically only the largest corporations or government agencies that are facing exceptional challenges are willing to commit the resources needed to construct a collaboration using currently available models.

The time required to identify opportunities for collaboration, to overcome anxieties about collaborating with competitors, and to construct the collaboration must be dramatically reduced in order to make collaborative funding of design, research, development, and/or delivery a realistic option regardless of the size of the project or the collaboration participants or the importance of the project.

### Philanthropic Collaborative Funding.

Collaborative campaigns in the philanthropic realm are long established and widely accepted. Individuals and groups contribute funds of varying amounts to fund a defined outcome such as the feeding of starving children in Africa or the construction of a library at the center of town.

Business enterprises currently are making no attempt to apply the existing philanthropic model to their design, research, development, and/or delivery projects because key requirements of successful commercial transactions are not met by the philanthropic model, including:

1) High efficiency. The philanthropic fund raising model is notoriously inefficient. Often fund raising campaigns are administered by an army of volunteers. This is not a viable option for most businesses. Well-established and highly successful philanthropic operations such as the American Red Cross or the United Way spend a large portion of the funds raised to pay for administrative and marketing costs of the fund raising drive. Typically, 20 percent or more of the money raised by charities is spent on such costs.

2) Binding Contract and Timely Communications. Most philanthropic gifts are given without any demand for a legal contract or purchase agreement and without any requirement for subsequent communications between the parties. The trust between the charity and the contributor is high, or the contributor would not make a donation. Not all states have laws that require donors to fulfill charitable pledges in the absence of written agreements, and not all states have laws that require charities to use the pledged funds for the purpose stated. Plus, most state law holds that a verbal contract is not binding if it calls for performance within a period exceeding one year. So, the philanthropic model lacks the mechanism to perfect a commercial contract that is binding on both parties especially if the project will not be completed within one year.

Although trust between Provider and Customer is important, precise documentation, a binding contract, certainty of the outcome, and timely communications from the Provider to the Customer are essential in today's economies. Responsible business professionals insist on these features especially because in most commercial enterprises the individual who executes the transaction is acting as an agent of either the Provider or the Customer. Accountability and verification depend upon precise documentation, timely communications, certainty of outcome, and enforceability of the contract. The costs of adding these features to the already inefficient philanthropic model are prohibitive.

3) Delivery of the Output to Customers. The philanthropic model delivers a single Output to a third party or to the community at large. That single Output may be disaster relief to a town destroyed by a tornado or the construction of a hospital. The Output is generally not delivered to the contributors. In the commercial realm the well being of the Customer is dependant upon the delivery of the Output to the Customer. A commercial transaction is typically not legally complete until the Provider delivers the Output to the Customer.

For obvious reasons, philanthropic organizations employing this model of collaborative funding have no motivation to deliver Outputs to Customers, so no mechanism to deliver Outputs to Customers exists in the philanthropic collaborative funding model.

On-Line Auctions with or without Bidding Pools.

Since the advent of the internet and the world wide web a number of on-line auction systems have been developed. Many of these systems conduct conventional auctions in which a seller makes an item available for competitive bidding by a plurality of potential buyers without requiring the buyers to meet at a physical location. Examples include eBay.com (U.S. Pat. No. 6,058,417) and Bid.com (U.S. Pat. No. 5,890,138). Other systems enable a plurality of buyers to pool their resources and bid jointly in an auction and, if successful, to subsequently divide the purchased goods or own them in common (U.S. Pat. No. 5,794,219). Priceline.com (U.S. Pat. No. 6,085,169) hosts “reverse auctions” in which a potential buyer proposes a price for an item to a plurality of sellers who individually have the option to accept or reject the bid.

All of the above auction models are vehicles to arrive at a maximum price at which a supplier agrees to sell an existing product or service to a customer. Accordingly, they are not viable models to determine the demand for and to fund the design, research, development, and/or delivery of goods and services in advance of the creation of such goods and services.

Additionally, unlike the present invention, which enables and encourages collaboration to bring about a shared output, auctions are competitive and pit possible price out of the single winning bidder.

### Other Dynamic Pricing Systems.

In addition to traditional auction models other dynamic pricing systems create the opportunity for different Customers to purchase the same good or service at different prices. Most notable are the stock and commodity exchanges at which the price of an equity or a good changes periodically over time as supply and demand shift. The creation of the internet and the world wide web stimulated the creation of dynamic markets for other goods and services. Importantly, within these systems, however, only one price can exist at any one point in time. Unlike the present invention, these other variable pricing systems do not provide a model for different Customers to publicly agree to pay different prices under the same terms and conditions at the same point in time.

### Collaborative Purchasing Systems.

Various collaborative purchasing systems have been developed and are available, especially since the advent of the internet and the world wide web. In nearly all industries, vendors sell a given product at lower unit prices as the quantity ordered increases. In general terms collaborative purchasing systems create purchasing pools in which a plurality of customers combine their orders for a single product and then search the market for the best price and/or purchase terms or engage vendors in negotiations for a single order of an existing product at the pool's combined quantity (U.S. Pat. No. 6,101,484.) Importantly, all existing collaborative purchasing systems shop or negotiate for existing products or services. The thrust of these systems is to modify the price curve for existing products or services by purchasing in collaborative bulk quantities. These systems do not have the capability of determining demand for and of pooling funds to be used for the design, research, development, and/or delivery of goods and services that do not currently exist.

### Negotiation Management and Design Collaboration Systems.

Various negotiation management and design collaboration systems exist; the most powerful operate over the internet. In general terms, these systems facilitate negotiations between buyers and sellers over the price and terms of sale of goods. The most sophisticate negotiation systems such as TradeAccess.com (U.S. Pat. No. 6,141,653) can create “communities” of buyers and sellers who can then engage in on-line, remote negotiations. The thrust of these systems is to bring into coordination the component design development stream of component suppliers with the design development stream of the purchaser's products that utilize the components while simultaneously negotiating price and delivery terms. These mechanisms differ from the present invention in that they are used to develop tighter coordination between the manufacturer and supplier ensuring delivery of components that closely fit the evolving needs of the buyer as well as delivery of said components in an efficient and timely manner. Available features of such systems include the ability to let suppliers readily view their product in a manufacturer's inventory and manufacturers to see a supplier's stock of the components the manufacturer purchases. Other features allow manufacturers to suggest changes to suppliers' products so they will better fit the future component requirements of the manufacturer's products.

None of these systems attempt to gauge the potential demand for proposed new Outputs, nor do they provide a model and/or apparatus to encourage and manage Customer collaborations to fund the design, research, development, and/or delivery of new Outputs by pooling binding advance purchase commitments.

### Equity Private Placements.

It is a long established standard practice in the business world to launch a new business by soliciting funds from investors in advance of launching the business enterprise. In these cases the founder prepares a business plan that defines product, organization, and marketing strategies together with projected sales and expenses for the near future. Based on this information potential investors decide whether to invest in the venture. Typically, the offering includes a minimum cumulative investment that must be achieved before the venture will be launched.

A critical difference between the present invention and the private placement model is that private placement investments, like all equity investments, are made to purchase equity in an enterprise without any legal commitment that a specific product or service will be delivered to the investor on a specific date. Equity investments are at-risk investments made to fund a stream of product or service developments as well as to fund capital and overhead expenditures of an on-going enterprise.

Because private placements concern the sale of equity ownership in a speculative venture, securities laws limit what can be said about a private placement and how it must be conducted. Additionally, the very nature of a private placement limits the terms of how the Output (in this case shares of stock) will be distributed. This is unlike the present invention, which allows and enables great flexibility in determining Output the same Output as other Customers who have contributed a different price. (See “Relative Value Bidding,” below.) While the present invention could be used to automate and improve the existing private placement process, this would represent a very limited embodiment of the invention's functionality.

### Price Discrimination.

Various models have long been followed that enable Providers to sell a given product or service to different Customers at different prices. These models are known as “price discrimination.” In all cases, the differing prices are justified and legal because the product or service is provided under different terms and conditions. A box of detergent may sell at one price off the shelf and at another price if the customer presents a discount coupon. The price to enter a movie theater may be higher in the evening than in the afternoon. The price of a new computer may be higher during the first six months following its release and lower thereafter. The price of two otherwise identical airline seats may differ significantly depending upon how much in advance the purchase is made and/or whether changes to the buyer's itinerary are subsequently permitted. Prior to the present invention with its Relative Value Bidding feature, no model existed, however, under which various Customers can collaboratively and publicly agree to pay varying prices for the same product or service under the same terms and conditions.

A method and apparatus capable of efficiently and effectively gauging the initial demand for an Output and funding, fully or partially, the Output by enabling and encouraging Customers to collaboratively commit to binding purchase orders for the Output prior to the Provider producing it, does not currently exist. Also, no method or apparatus currently exists to enable a plurality of Customers to collaboratively and publicly agree to pay varying prices for the same good or service under the same terms and conditions.

### SUMMARY OF THE INVENTION

It is an object of this invention to facilitate the formation of efficient and reliable business collaborations, particularly among Providers and their current and/or potential Customers, to fund the design, research, development, and/or delivery of new Outputs. The design, research, development, and/or delivery of many potential Outputs is prohibitively expensive for a single Customer or Provider to fund alone. The facilitation of collaborations provided by this invention will produce many new and valuable Outputs that are not currently manifested by existing methods.

It is also an object of this invention to effectively and efficiently enable Providers to accurately gauge initial demand for proposed new products and services by offering a means for Customers to vote for their preferences with binding advance purchase commitments. Vast amounts of Providers' time and money are currently devoted to surveying potential customers and predicting potential demand for new Outputs, but the rate of new Output failures throughout the world's economies due to inaccurate demand predictions is very high.

It is a further object of this invention to enable Providers to fund the design, research, development, and/or delivery of new products and services from Customers binding advance purchase commitments rather than from equity sales, borrowing, and/or the diversion of enterprise cash flow. The vast amounts of money that must be devoted to new Output development and delivery is a very significant drain on the financial resources of enterprises dependent upon new Output development. This invention can significantly lessen Providers' need to sell equity, borrow, and/or divert cash flow.

Yet another object of this invention is to provide a method and apparatus through which a plurality of collaborative Customers can openly agree to pay different prices for the same good or service under the same terms and conditions depending upon the relative value of the Output to each collaborating Customer. For example, a large enterprise may be able to save many thousands of dollars if a new inventory control software feature is made available. A smaller enterprise may be able to save only a few thousand dollars if the new software is made available. Large enterprises may be happy to pay relatively high prices to obtain the feature while smaller enterprises may be able to justify only a much lower price. This invention can enable Providers to generate revenues needed to justify the creation of a new Output in cases where no single price can be found that would stimulate sales adequate to earn the Provider an adequate profit.

It is also an object of this invention to reduce the prices of successful new products and services by reducing the expense of new product and service failures since the expense of such failures must typically be recouped by an enterprise in the price of their successful new products and services.

The invention, the Collaborative Funding Engine (the Engine) is a method of predicting initial demand for and collaboratively funding of the design, research, development, and/or delivery of an Output over a communications network. The method includes defining the Output by means of a specification, establishing a predetermined total compensation (the Hurdle Level) required by a Provider to supply the Output in accordance with these specifications, and establishing terms for funding and supplying the Output.

A Collaborative Funding Pool is established by posting the Output specification, terms, and Hurdle Level to a public communications area on the communications network that is accessible to Customers who may have an interest in the Output and who may be willing to contribute at least a portion of the required Hurdle Level.

The Engine can then receive binding Contingent Purchase Orders from a plurality of Customers who agree to participate in the Collaborative Funding Pool, with each Contingent Purchase Order constituting a binding offer to contribute a portion of the specified Hurdle Level representative of what each Customer is willing to contribute for the Output should the Hurdle Level be reached.

The Contingent Purchase Order also binds the Provider to supply the Output according to the stated specifications and terms should the Hurdle Level be achieved.

The Engine's notification module informs participating individuals among both Customers and Providers (the Participants) of selected information about events pertaining to the status of the various Collaborative Funding Pools and motivates collaborative activity among the Participants.

The presently preferred embodiment of the invention, the Collaborative Funding Engine (the Engine), facilitates the design, research, development, and/or delivery of application software (the Application) by an Independent Software Vendor (ISV) database computer system designed to link the computer network of the ISV Provider to a plurality of its Customer networks (or single user systems) via a web server linked through the Internet. This embodiment can also reside and operate effectively on other communications networks currently existing and to be developed in the future. The Provider utilizes the Engine to gauge demand for various functional improvements to, and/or new features for, the Application as well as to fund or partially fund some or all of those improvements and/or new features in advance of their development. Customers are notified of potential new features and improvements and are encouraged to participate in the funding of them through communications among both the Provider and other Customers as managed by the Engine's Notification Management Module. As is obvious to anyone skilled in the art, such an ISV Provider could also be the developer and supporter of numerous software Applications as well as be a provider of custom software development. It is also obvious to those skilled in the art that a third party could host the Engine on a remote network site through which the ISV Provider manages the development of Collaborative Funding Pools among Provider Customers.

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings in which:

FIG. 1 is a Database Software Summary Overview diagram OV1 of the database tables TBL-05 to TBL-80 and the six software module groups, 100 Series to 600 Series, in accordance with the present invention.

FIG. 1(A) is the first part of a Database Software Detail Overview diagram OV2 of the database tables TBL-05 to 80 and the six software module groups, 100 Series to 600 Series, in accordance with the present invention.

FIG. 1(B) is a continuation of the Database Software Detail Overview diagram OV3.

FIG. 2 provides an overview of a typical Hardware Configuration including both a basic Provider's 10 in-house network LAN1 and one Customer 20 network LAN2 for implementing the structure of FIG. 1. Typically, a plurality of Customer networks LAN2 would be linked to the Provider's network LAN1 via the Internet 30 or other communications network.

FIG. 3 is the Database Table Entity Relational Diagram (ERD) showing the relationships of the sixteen database tables TBL-05 to TBL-180 in accordance with the present invention.

FIG. 4 provides a content outline of sample principal Web Pages comprising the Website.

FIG. 4(A) illustrates the Website home page named the Development Center.

FIG. 4(B) illustrates the Web Page for the Collaborative Funding Pool Joint Bids listings.

FIG. 4(C) illustrates the Web Page for a sample Check Pay Multiple Vouchers Funding Pool Joint Bid.

FIG. 4(D) illustrates the Web Page for the Contingent Purchase Order Submittal Form.

FIG. 4.1 illustrates the Collaborative Funding Pool Web Page creation 4.1(A).

FIG. 4.2 illustrates the Contingent Purchase Order Web Page 4.2(A) creation.

FIG. 4.3 illustrates the (optional) Under Development Web Page 4.3(A) creation.

FIG. 4.4 illustrates Other Web Page 4.4(A) creations.

FIG. 5 illustrates the Participant Registration Process 110 for the corresponding module shown in FIG. 1(A).

FIG. 6 illustrates the Collaborative Funding Pool Creation Process 210 for the corresponding module shown in FIG. 1(A).

FIG. 7 illustrates the Contingent Purchase Order Submittal Process 310 for the corresponding module shown in FIG. 1(A).

FIG. 8 illustrates the Collaborative Funding Pool Update Process 220 for the corresponding module shown in FIG. 1(A).

FIG. 9 illustrates the Collaborative Funding Pool Expiration Process 230 for the corresponding module shown in FIG. 1(A).

FIG. 10 illustrates the Collaborative Funding Pool Delivery Process 240 for the corresponding module shown in FIG. 1(A).

FIG. 11 illustrates the (optional) Wish Origination Process 410 for the corresponding module shown in FIG. 1(A).

FIG. 12 illustrates the (optional) Wish Vote Submittal Process 420 for the corresponding module shown in FIG. 1(A).

FIG. 13 illustrates the (optional) Wish Expiration Process 430 for the corresponding module shown in FIG. 1(A).

FIG. 14 illustrates the (optional) Wish Conversion to a Collaborative Funding Pool Process 440 for the corresponding module shown in FIG. 1(A).

FIG. 15 illustrates the (optional) Wish Delivery Process 450 for the corresponding module shown in FIG. 1(A).

FIG. 16 illustrates the (optional) Bug Registration Process 510 for the corresponding module shown in FIG. 1(A).

FIG. 17 illustrates the (optional) Bug Fix Delivery Process 520 for the corresponding module shown in FIG. 1(A).

FIG. 18 illustrates the (optional) Bug Notification Request Process 530 for the corresponding module shown in FIG. 1(A).

### DETAILED DESCRIPTION OF THE INVENTION

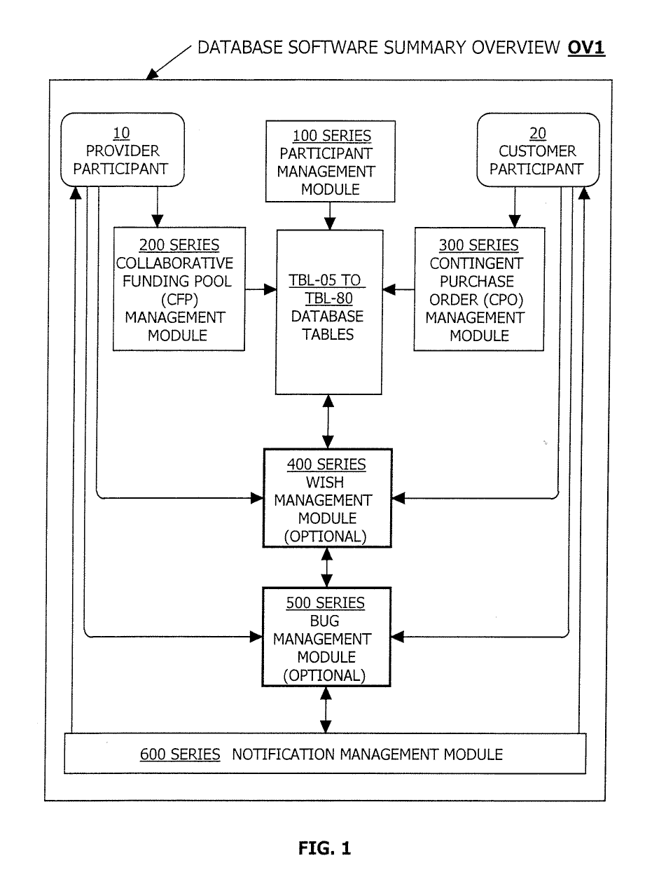

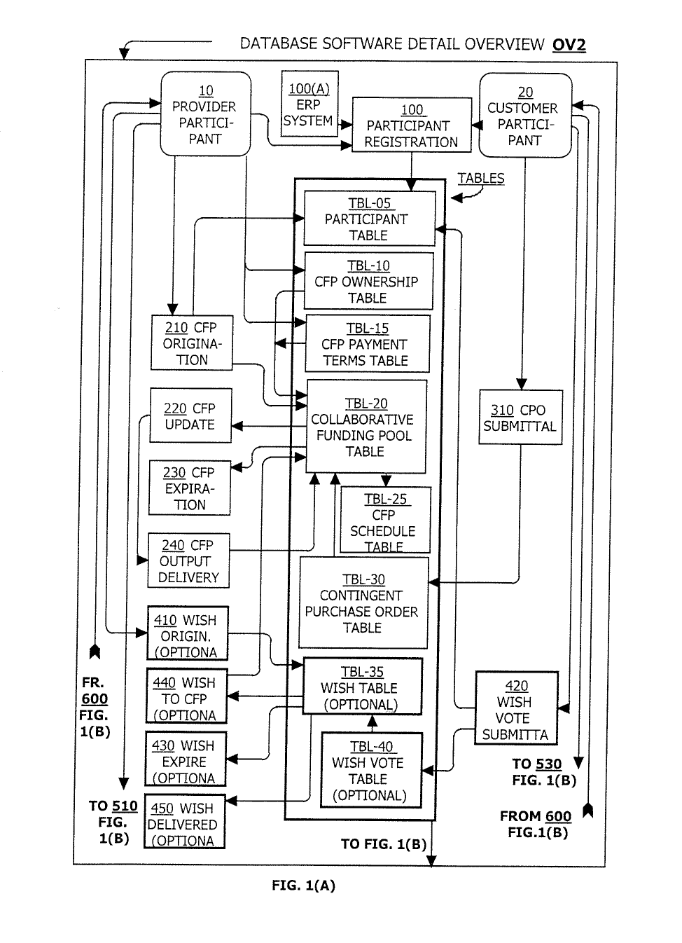

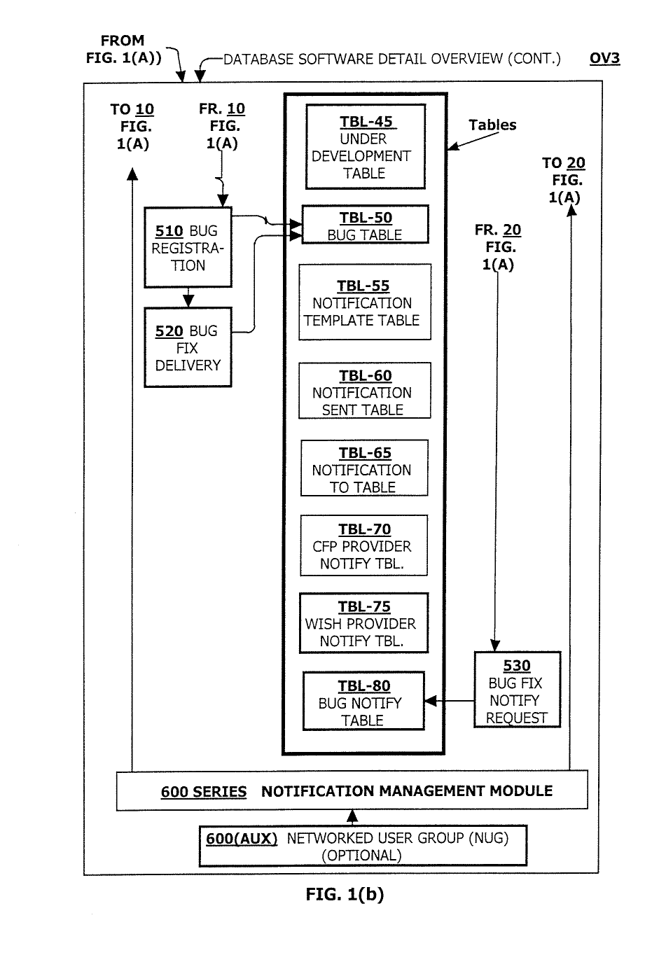

FIG. 1 illustrates the Database Software Summary Overview OV1, which is a summary overview of the software of the presently preferred embodiment. This embodiment utilizes a relational database. The database software is comprised of a series of database tables TBL-05 to TBL-80 and six groups of software modules 100 Series to 600 Series of which the 400 Series and the 500 Series are optional. The data input and management is facilitated and controlled by the six software module series. The Participant Management Module 100 Series controls the input and validation of all users of the Engine including both Providers 10 and Customers 20. The Collaborative Funding Pool (CFP) Management Module 200 Series controls the creation of CFP's (including specifications and terms) by the Provider 10 and receipt and tracking of valid Contingent Purchase Orders (CPOs) from Customers 20. The Contingent Purchase Order (CPO) Management Module 300 Series controls the creation of CPOs by Customers 20, CPO validation, and CPO submittal to the appropriate Collaborative Funding Pool. The (optional) Wish Management Module 400 Series controls the creation of Wishes (typically, desired modifications to and/or enhancements of a Provider 10 application software) by either Customers 20 or Providers 10, the receipt of Wish Votes from Customers 20, the conversion of Wishes to Collaborative Funding Pools or other forms of Provider 10 development, and the elimination of Wishes from the table. The (optional) Bug Management Module 500 Series controls the registration of bugs that have been identified in Provider 10 application software, the scheduling of bug fixes, and the announcement and delivery of the completed bug fix. The Notification Management Module 600 Series is an interactive community communication module that links Providers 10 and Customers 20 through internet web postings and email notices of appropriate news and inquiries and includes the (optional) Under Development Table TBL-45.

The essential software modules are the series of tables, the Participant Management Module 100 Series, the CFP Management Module 200 Series, the CPO Management Module 300 Series, and the Notification Management Module 600 Series because they are needed to validate Participants, establish Collaborative Funding Pools (CFPs), accept Contingent Purchase Orders (CPOs), and build and maintain collaborations through frequent communications among the Participants.

The presently preferred embodiment includes two optional software modules: the Wish Management Module 400 Series and the Bug Management Module 500 Series, which adapt the Engine to the Independent Software Vendor (ISV) environment.

FIGS. 1(A) and 1(B) illustrate the Database Software Detail Overview OV2 and OV3, which shows the components of the database tables and six software modules:

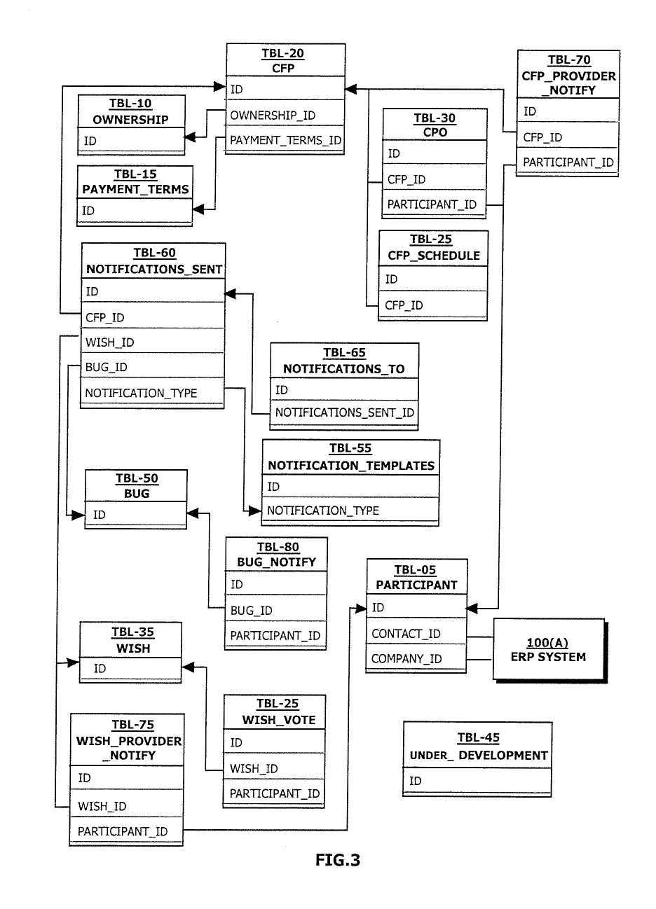

1. Table structure [TBL-05 to TBL-80] of this presently preferred embodiment consists of a database with sixteen tables: Participant Table TBL-05, Collaborative Funding Pool Ownership Table TBL-10, Collaborative Funding Pool Payment Terms Table TBL-15, Collaborative Funding Pool Table TBL-20, Collaborative Funding Pool Schedule Table TBL-25, Contingent Purchase Order Table TBL-30, (optional) Wish Table TBL-35, (optional) Wish Vote Table TBL-40, (optional) Under Development Table TBL-45, (optional) Bug Table TBL-50, Notification Templates Table TBL-55, Notifications-Sent Table TBL-60, Notifications-To Table TBL-65, Collaborative Funding Pool Provider-Notify Table TBL-70, (optional) Wish Provider-Notify Table TBL-75, and (optional) Bug Notify Table TBL-80. [See FIG. 3, “Database Table Entity Relationship Diagram,” for the relationship of these tables to each other. See “Table Specifications”, below, for the attributes of these tables.] One skilled in the art can readily see that additional tables can and/or need to be added to this table structure to add enhancements and/or make modifications needed for other applications of this presently preferred embodiment and/or other embodiments.

2. Participant Management Module [100 Series] consists of: Participant Registration Process 110 and ERP Download Process 110(A).

3. Collaborative Funding Pool (CFP) Management Module [200 Series] consists of: CFP Origination Process 210, CFP Update Process 220, CFP Expiration Process 230, and CFP Output Delivery Process 240.

4. Contingent Purchase Order (CPO) Management Module [300 Series] consists of: CPO Submittal Process 310.

5. Wish Management Module [400 Series] (optional) consists of: Wish Origination Process 410, Wish Vote Submittal Process 420, Wish Expiration Date Check Process 430, Wish Conversion to CFP Process 440, and Wish Output Delivery Process 450.

6. Bug Management Module [500 Series] (optional) consists of: Bug Registration Process 510, Bug Fix Delivery Process 520, and Bug Fix Notification Request Process 530.

7. Notification Management Module [600 Series] consists of an array of notification triggers and notices (illustrated and described in the Figures that follow.) Optionally, the Notification Management Module 600 Series can be linked to a Provider Networked User Group (NUG) 600 (AUX).

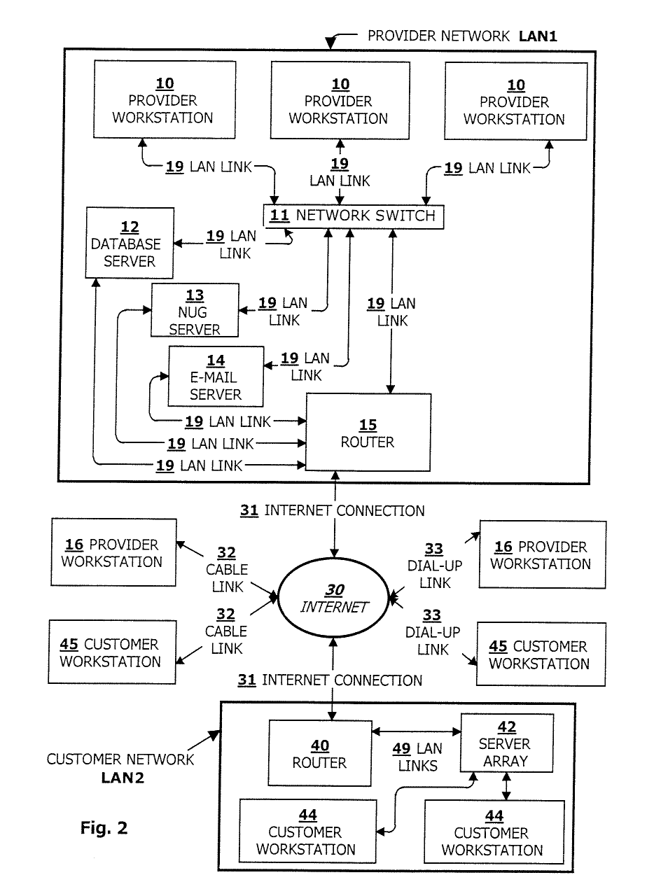

FIG. 2 illustrates a basic Hardware Overview of this presently preferred embodiment. The Provider Local Area Network (LAN) LAN1 connects to the oval symbol representing the Internet 30 below which is one Customer Local Area Network (LAN) LAN2. To each side of the Internet 30 oval are remote Provider Participant 10 and Customer Participant 20 workstations, of which there may be many of both. A typical configuration would include a plurality of Customer LANs LAN2. As is apparent to one skilled in the art, networks other than the Internet may be utilized by the invention.

Provider Local Area Network (LAN) LAN1. The Provider network LAN1 is shown as a local area network (LAN) with LAN Connections, or Links, 19 between local Provider Workstations 10 and the Network Switch 11. On the other side of the Network Switch reside the Provider file servers 12, 13 & 14: the Database Server with Web Server 12, the Network Users Group (NUG) Server 13, and the eMail Server 14. Any number of other Provider 10 file servers or file server configurations could also reside on their LAN LAN1. The array of file servers and the Network Switch connect to the Provider's Router 15, which routes data entering the Provider LAN LAN1 and also houses the LAN firewall and anti-virus software. The Router connects the Provider LAN LAN1 and all of its Workstations to the Internet via a full-time Internet Connection 31, as available. Additional Provider Workstations 16 may exist at remote locations and connect to the Provider LAN LAN1 via the Internet through Cable Modem, DSL, or other broad-band connections 32 or Dial-Up Connections 33.

Customer Local Area Network LAN2. The typical Customer LAN LAN2 would include a configuration appropriate for the individual Customer's 20 needs that likely includes a router 40, a server array 42, and any number of Customer Workstations 44 linked via LAN Connection, or Links, 49. Additional Customer Workstations 45 may access the Customer LAN LAN2 via the Internet through Cable Modem, DSL, or other broad-band connections 32 or Dial-Up Connections 33. In a typical configuration of the presently preferred embodiment a plurality of Customer 20 networks LAN2 would link to the Provider's 10 network LAN1 via the Internet 30 or other communications network.

FIG. 3 is the Database Table Entity Relationship Diagram (ERD), which shows the relationships of the sixteen database tables to each other. These relationships have been organized to minimize data duplication and maximize reaction speed according to the attributes of the particular relational database software utilized, as would be apparent to one skilled in the art. Those skilled in the art of database design will also appreciate that other schemas can be designed to afford the same functionality, based on the attributes of the database tool utilized. The Table fields shown below the table captions in this figure represent the key and foreign key fields (the unique identifiers) in each Table. Complete field descriptions of each of the sixteen Tables in this presently preferred embodiment are shown in “Table Specifications,” below.

The purpose of each Table in this presently preferred embodiment are:

Participant Table TBL-05. The Participant Table stores identifying data for all individuals authorized to enter and use the Collaborative Funding Engine, including their Notification Preferences. Participants include authorized individuals associated with both the Provider 10 and Customers 20. The Table has been designed so it can readily communicate with a separate, corporate Enterprise Resource Planning (ERP) system 110(A) (if desired) so that data such as Company Name, eMail Address, etc. can be synchronized. Typically when the database is initially set up, Participant 10 or 20 information is downloaded from the ERP system 110(A). This facilitates Participant 10 or 20 registration on the website since the Participant Table TBL-05 already contains the Participant's 10 or 20 key data. Additionally, if the synchronization function is used, as new Customers 20 purchase a Provider 10 application the relevant Customer Participant 20 data is automatically added to the Participant Table TBL-05. Furthermore, if a Customer Participant 20 submits an email or name change to the ERP administrator, the process of updating the ERP system will automatically update the Participant Table TBL-05 as well. The Participant Table TBL-05 also maintains data about authorized individuals who are employed by or associated with the Provider 10, appropriate (optional) Network User Group 600(AUX) parties, and authorized individuals associated with any other list servers utilized.

Ownership Table TBL-10. This table stores ownership information that describes the ownership (if relevant) of the Output of a completed Collaborative Funding Pool (CFP). Provider Participants 10 can initiate CFPs employing a wide variety of ownership terms such as CFPs in which Customers 20 enjoy no ownership of the Output or other CFPs in which Customers 20 receive equity or royalty rights ownership of the Output. A Provider Participant 10 enters any desired number of ownership terms in the Ownership Table when setting up the database. When a Provider Participant 10 creates a CFP she selects the desired Ownership Terms for that CFP from the Ownership Terms Table or, if necessary, adds additional Ownership Terms to the Table as required for the new CFP. The ownership information is displayed on the Provider's 10 CFP detailed description web-page and the CPO web-page as well as the CPO submittal confirmation notification.

Payment-Terms Table TBL-15. This table stores a variety of payment terms required of the Customer 20 for different Collaborative Funding Pools (CFPs). Terms can require Customers 20 to make payments when the Hurdle Level is reached, when the Output is delivered, or any other variety or combination of Payment Terms. When a Provider Participant 10 creates a CFP he selects the desired Payment Terms for that CFP from the Payment Terms Table TBL-15 or, if necessary, adds additional Payment Terms to the Payment Terms Table TBL-15 as required for the new CFP. The information is published on the CFP detailed description web-page and the CPO web-page as well as the CPO submittal confirmation notification.

Collaborative Funding Pool (CFP) Table TBL-20. This table stores all attributes of all CFPs other than the Ownership and Payment Terms including but not limited to summary descriptions and detailed specifications of the proposed Outputs and their Expiration Dates, Hurdle Levels, and cumulative CPO values committed to the CFPs to-date. CFP specifications can include the requirement that the Provider 20 purchase a performance bond. By default a CFP is “public,” which means that all Participants 10 or 20 can view the Customer Participant 20 Name, Customer Participant 20 Company, and CPO Amount of all CPOs submitted. (See “Contingent Purchase Order Table TBL-30,” below.) An authorized Provider Participant 10 can designate a CFP as “private,” which means that CPO details are hidden.

Collaborative Funding Pool (CFP) Schedule Table TBL-25. A CFP can be a powerful tool for a Provider 10 for scheduling training sessions, meetings, demonstrations, and many other activities that require a plurality of people to congregate at a specified location or tune into a specified communication space, including but not limited to a web site, telephone conference call, or television channel, at a specified time. This table is used to store data for such time-based meetings and training sessions. When a time-based CFP is created and posted, it can include one or more proposed schedules. Each CPO submitted specifies which schedule is desired. As Customer Participants 20 see which of the schedules are getting the most support from other Customer Participants 20, they can resubmit their CPO with a more popularly supported schedule to ensure their participation and to help the CFP reach its Hurdle Level. A time-based CFP does not close until the Hurdle Level is met for one specific schedule. In other words, the Hurdle Level is specific to a single schedule, not all schedules in combination.

Contingent Purchase Order (CPO) Table TBL-30. The CPO table stores all CPO data for all submitted Contingent Purchase Orders. This includes the amount, the submitting Customer Participant name, the date, and the (optional) digital signature. The CPO mechanism binds both the Customer Participant 20 to pay the specified amount according to the Payment Terms of the Collaborative Funding Pool (CFP) and the Provider 10 to supply the defined CFP Output according to the CFP specifications when the CFP Hurdle Level is reached.s

Wish Table TBL-35 (optional). A Wish identifies an Output desired by one or more Participants 10 or 20. The Wish Management Module 400 Series is a powerful tool enabling the Provider 10 to continually and interactively poll its Customers 20 to learn what product and/or service introductions and/or enhancements are most desired by its Customers 20. A Wish is usually created on the basis of a request submitted by a Customer Participant 20 to the Provider 10 through the Wish section of the website, phone, email or other means. An authorized Provider Participant 10 may choose to include a popular Wish in the application without the support of Customer 20 Contingent Purchase Orders, or an authorized Provider Participant 10 may convert the Wish into a Collaborative Funding Pool (CFP) to determine whether Customers 20 desire the Wish enough to commit Contingent Purchase Orders (CPOs) to fund its development.

Wish-Vote Table TBL-40 (optional). This table records the number of Customer Participant 20 Wish Votes received for a defined Wish in the Wish Table TBL-35. In this presently preferred embodiment only one Wish Vote is permitted per Customer 20, however, as is obvious to one skilled in the art, the module could be structured to permit a Wish to receive Votes from a plurality of Participants associated with the same Customer 20. As is further obvious to one skilled in the art, Wish attributes could permit Provider Participants 10 (or only Provider Participants 10) to vote on given Wishes.

Under-Development Table TBL-45 (optional). Some Application features developed by the Provider 10 may not be originated through the Collaborative Funding Pool or Wish processes. For example, the Provider 10 may independently decide to add a new feature to an application or to develop a new application. The Under Development Table TBL-45 enables the Provider 10 to record, track, and communicate these development efforts to all appropriate Participants 10 or 20.

Bug Table TBL-50 (optional). The Bug Table stores descriptions of known software bugs reported by users to the Provider 10. It links to the Bug Notify Table TBL-80 (see below), which enables Participants 10 or 20 to review a list of known bugs and to be informed when a bug fix is delivered.

Notification-Templates Table TBL-55. The records in this Table define templates used to build automatic notifications to Participants 10 or 20. For a description of common notification-template types see “Notification Types Record Examples” on the pages following “Notification-Templates Table Specifications TBL-55.”

Notifications-Sent Table TBL-60. A Notification is an automated email message or web site posting that notifies a Participant 10 or 20 that an event has occurred on the Engine (e.g., the posting of a new Collaborative Funding Pool) or that a milestone based on Engine activity has been reached (e.g., a Collaborative Funding Pool has reached its Hurdle Level). Since the exact same notification may be sent to many Participants 10 or 20, the sent-to Participant information is not stored in the Notification-Templates Table TBL-55 but rather in the Notifications-To Table TBL-65, described below. In order to generate automatic Notifications, the text of each Notification is derived from the Notification Templates Table TBL-55.

Notifications-To Table TBL-65. This Table contains one record for each Participant 10 or 20 to whom each notice has been sent. It enables the same Notification to be sent to multiple Participants 10 or 20 without requiring the text of each separate Notification to be stored.

Collaborative Funding Pool (CFP) Provider-Notify Table TBL-70. This table is used to record which Provider Participant(s) 10 need to be notified of activities and events associated with specified CFPs.

Wish-Notify Table TBL-75 (optional). This table is used to record which Provider Participant(s) 10 need to be notified of activity in the Wish Table TBL-35.

Bug-Notify Table TBL-80 (optional). The Bug-Notify Table maintains a list of Participants 10 or 20 who wish to be notified when a specified software bug is fixed. On the Bug Table TBL-50 website page the Participant 10 or 20 may click a “Bug Notification Request” button to add the Participant's 10 or 20 name to the Bug-Notify Table TBL-80.

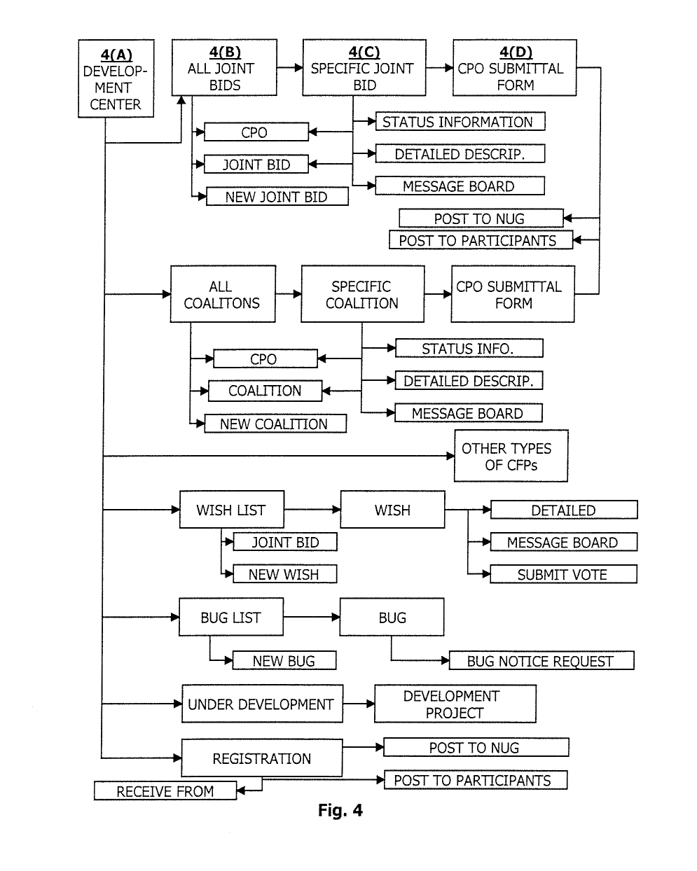

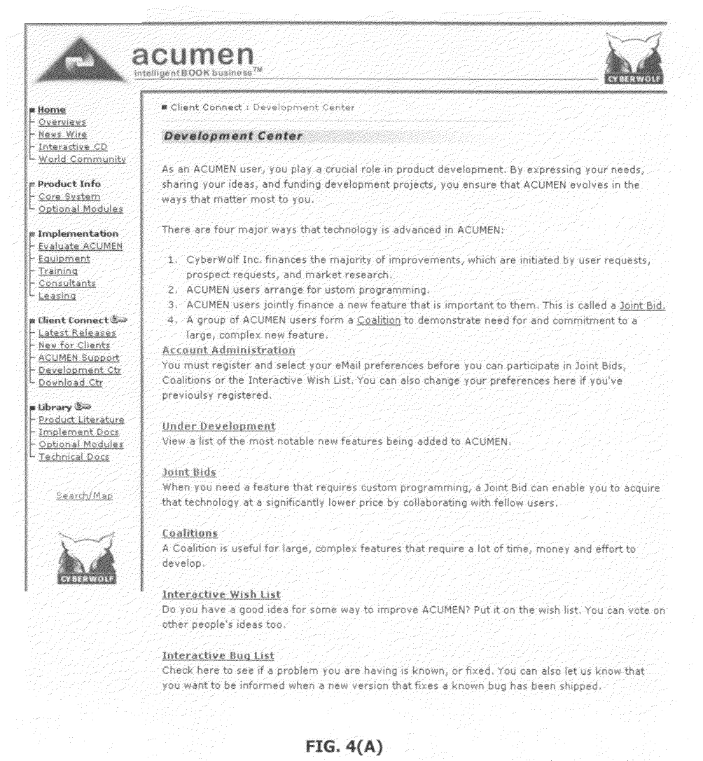

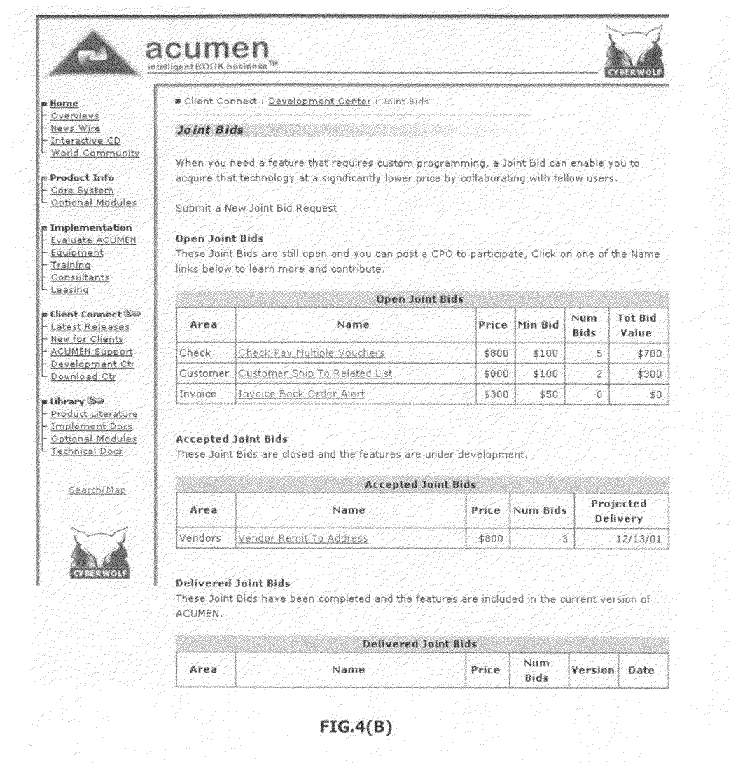

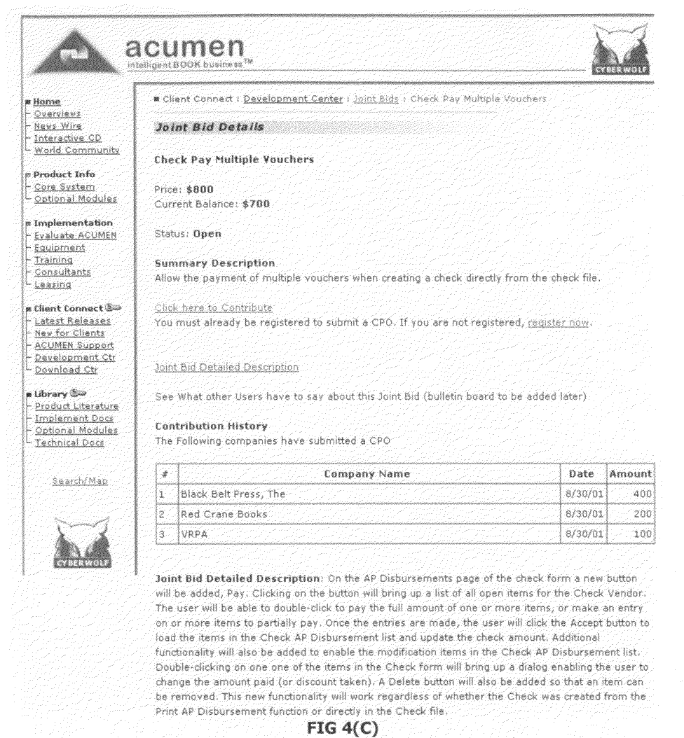

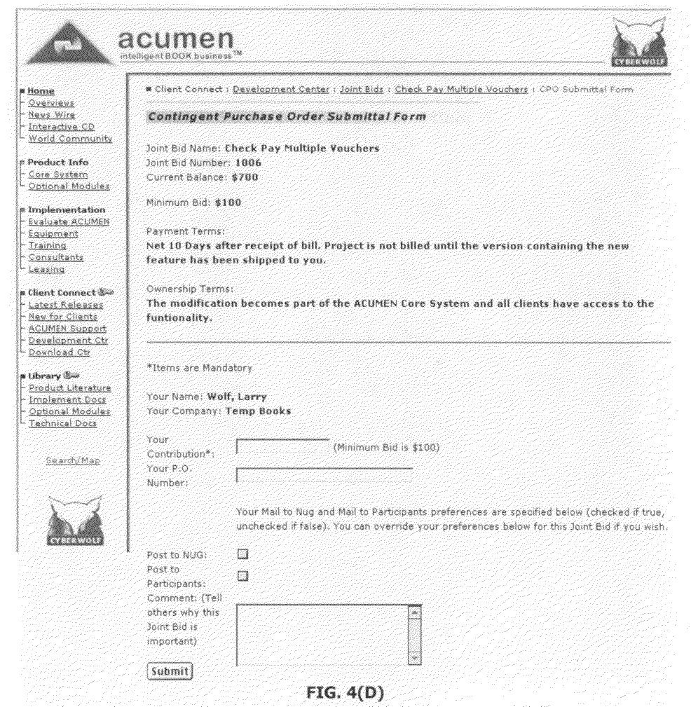

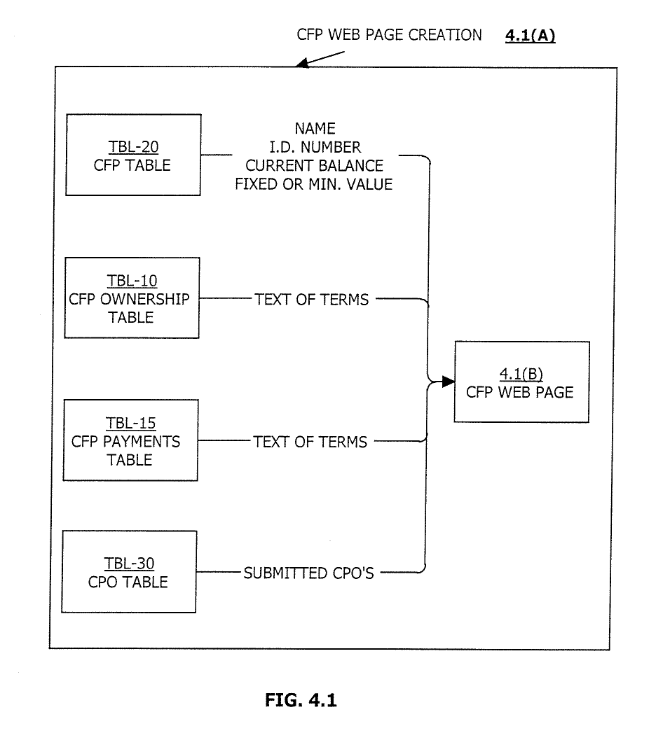

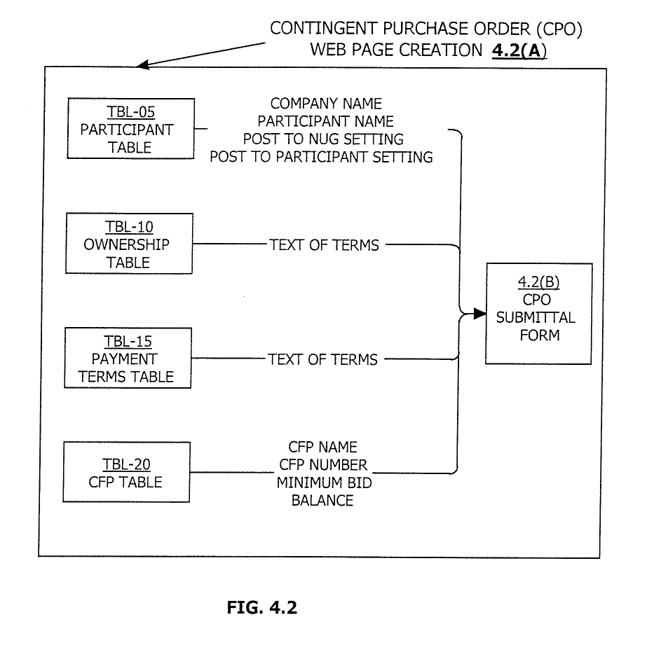

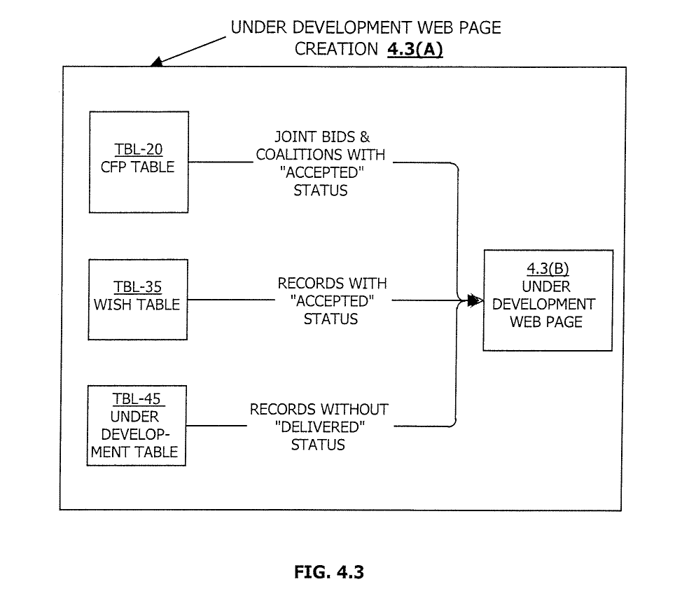

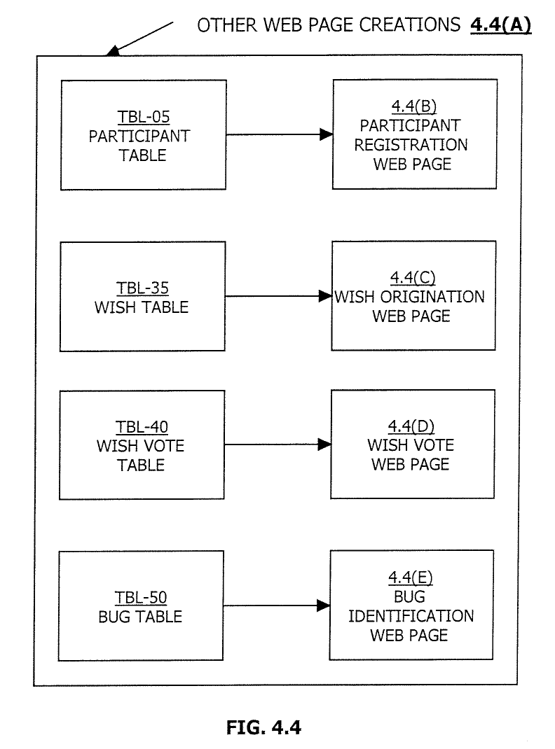

FIG. 4 provides an overview of a Website Structure for the presently preferred embodiment used by the Provider 10 to enable Customers 20 to participate in the Collaborative Funding Engine. Each box on this diagram represents a web page on the typical Engine website. For simplicity sake, the complete website structure is not disclosed, as one skilled in the art of website design can appreciate. However, the most important pages are included. Throughout the website are access links to public communications areas such as message boards and bulletin boards that permit and encourage both Provider 10 and Customer 20 Participants to initiate and participate in discussions about Collaborative Funding Pools and Wishes.

Sample Web Pages. Sample web pages (FIG. 4(A) to FIG. 4(D)) provided to illustrate one of many possible web site designs. Other web pages are not discussed in detail because they would be self evident to one skilled in the art and would be different for each application. The sample pages shown 4(A) to 4(D) are examples from the web site of an Independent Software Vendor (ISV) Provider named CyberWolf and feature the Provider's book publishing software application named ACUMEN.

The first sample page of this sample embodiment shows the ACUMEN Development Center 4(A) home page. It features links to two types of Collaborative Funding Pools (CFPs), the Joint Bids and the Coalitions, as well as access to Participant Registration 110 through “Account Administration”, the Under Development Table (optional) TBL-45, the Wish Table (optional) TBL-35, and the Bug Table (optional) TBL-50.

The second sample page 4(B) shows the ACUMEN Collaborative Funding Pool (CFP) Joint Bids listings. The three lists display CFP Joint Bids of different statuses, “Open,” “Accepted,” and “Delivered.” From this page one can access a specific CFP Joint Bid by clicking on its link.

The third sample page 4(C) displays the information for a sample “Check Pay Multiple Vouchers” CFP Joint Bid. It is accessed by clicking on the “Check Pay Multiple Vouchers” link in 4(B). The “Click Here to Contribute” link, enables the Customer Participant 20 to access the Contingent Purchase Order (CPO) Submittal Form for this CFP. This CPO Submittal Form enables the Customer Participant 20 to submit a binding CPO for the “Check Pay Multiple Vouchers” Collaborative Funding Pool.

In order to build many of the web pages, data must be drawn from Tables in the database, as described below in FIG. 4.1 to FIG. 4.4.

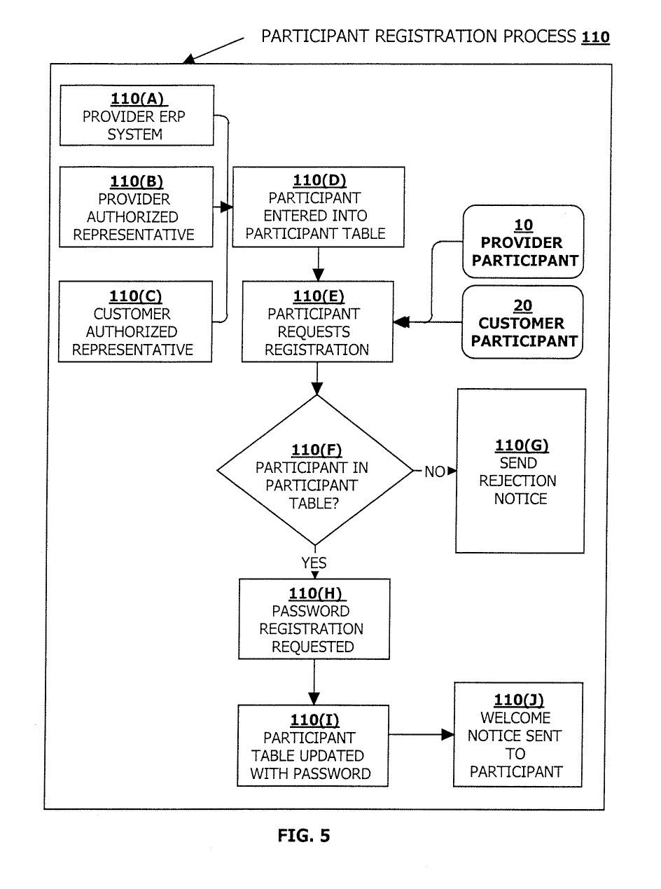

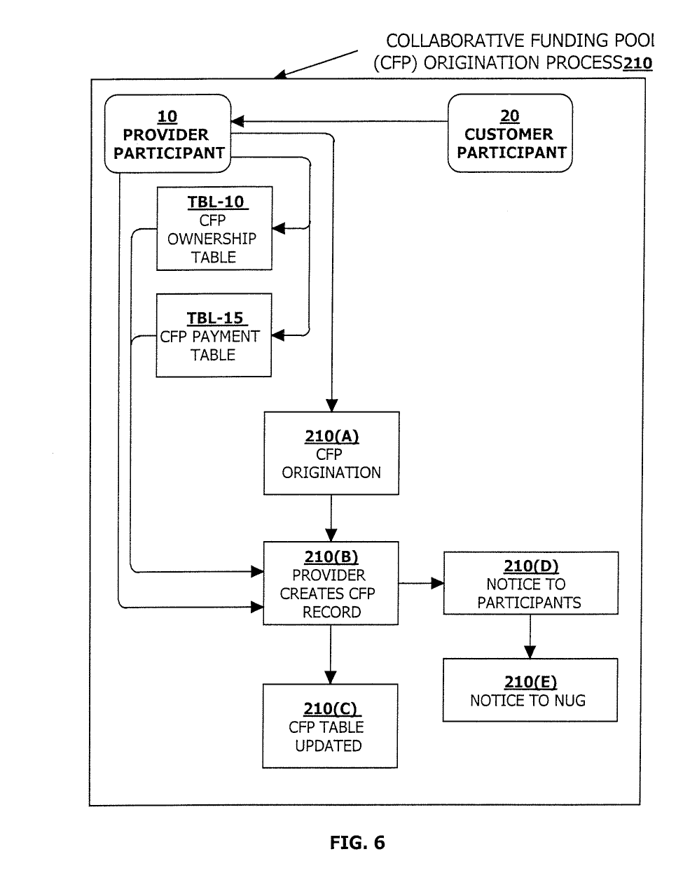

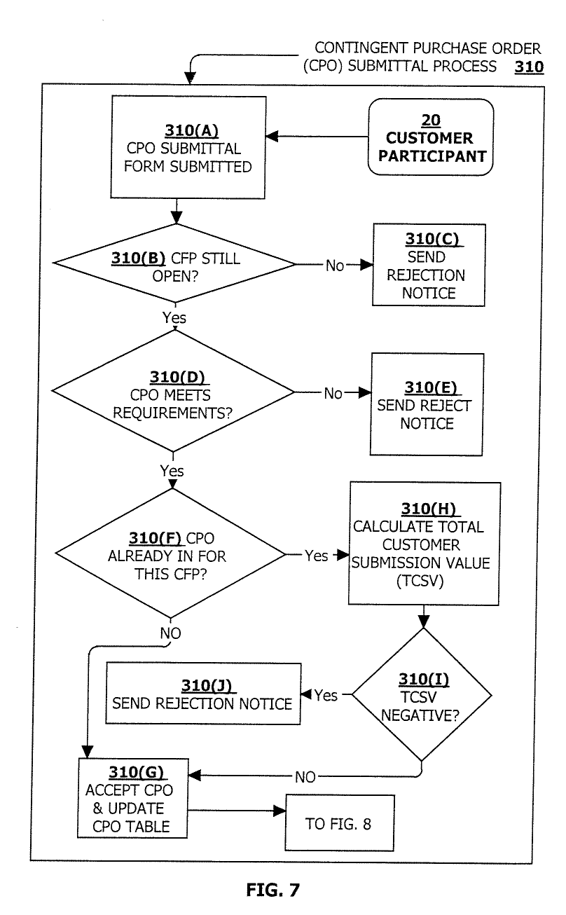

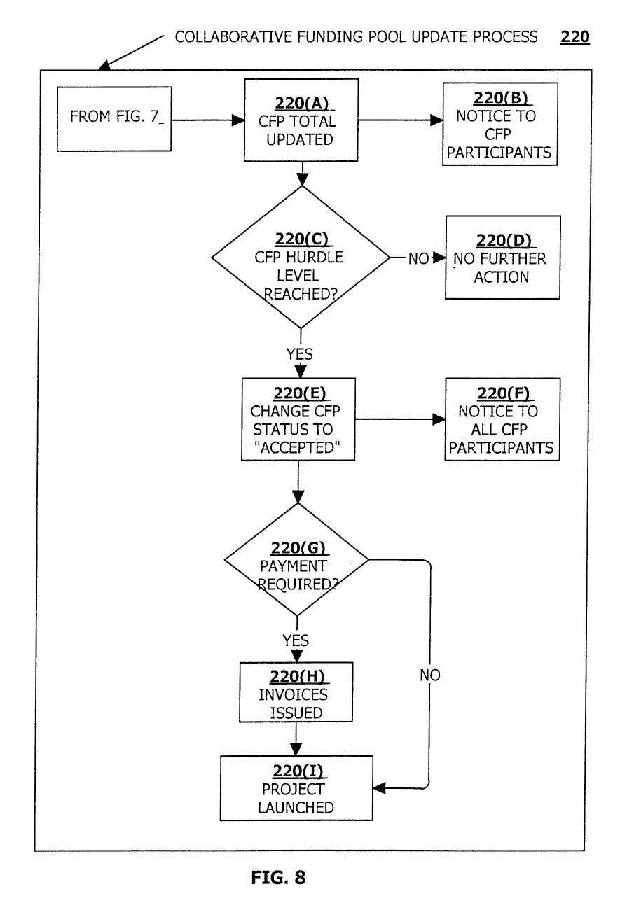

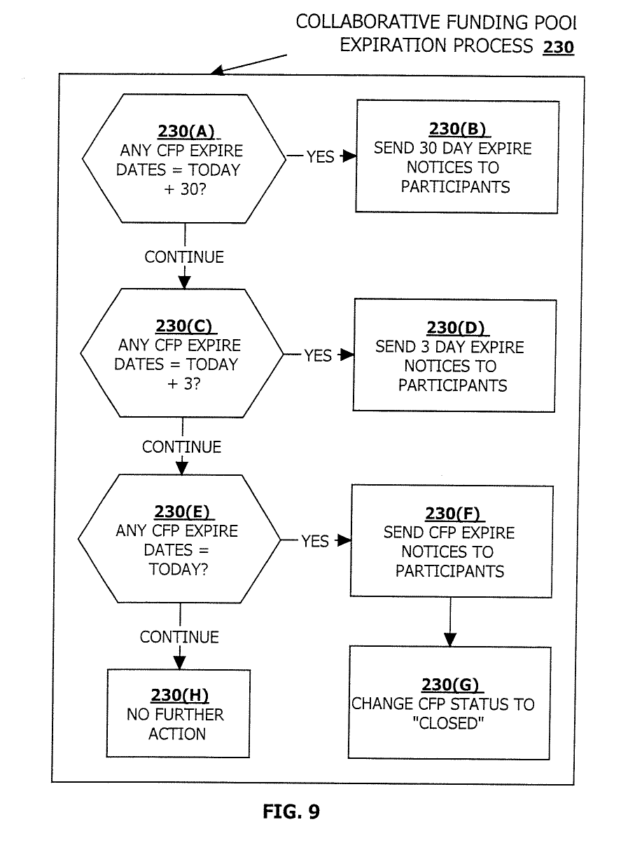

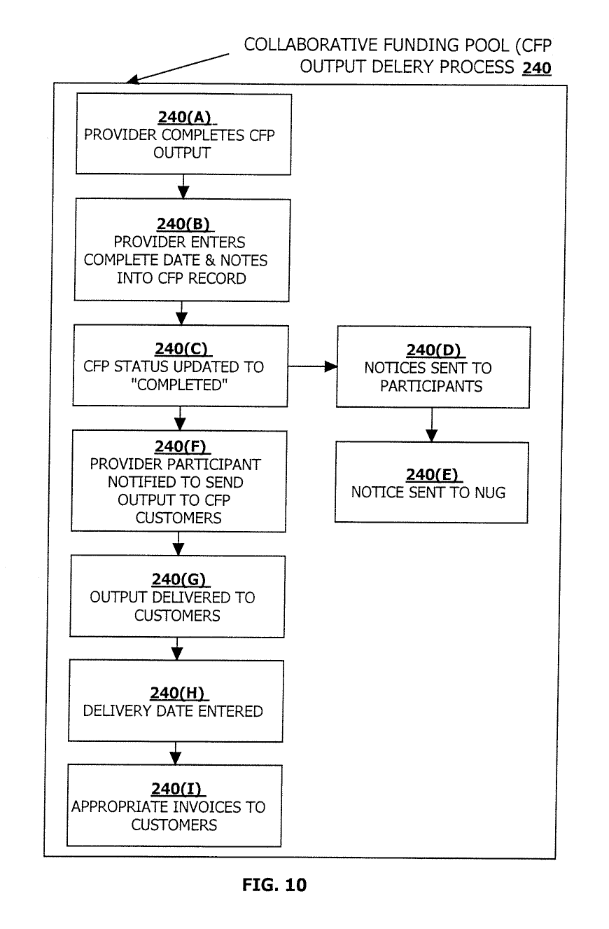

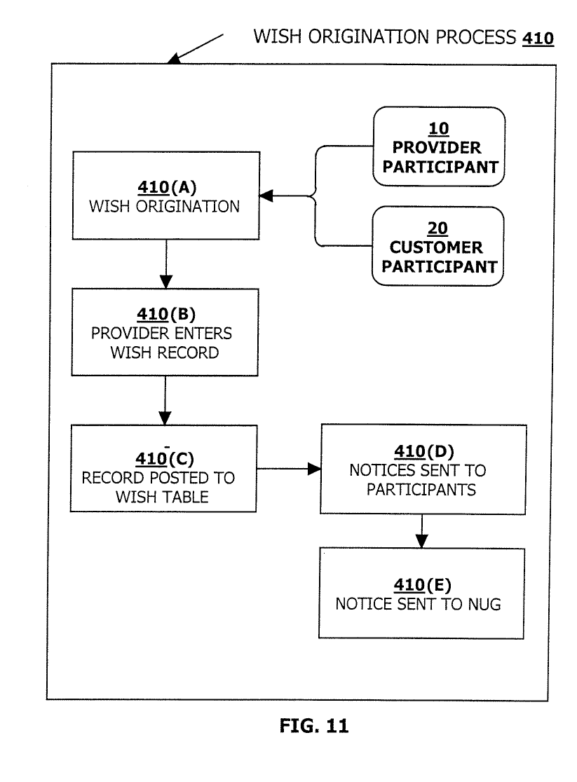

FIG. 4.1 illustrates that a Collaborative Funding Pool (CFP) Web Page 4.1(B) is built by drawing the Name, ID Number, Current Balance and Fixed or Minimum Bid Value from the Collaborative Funding Pool (CFP) Table TBL-20, the text of the ownership terms from the CFP Ownership Terms Table TBL-10, the text of the payment terms from the CFP Payment Terms Table TBL-15, and the submitted Contingent Purchase Orders (CPOs) from the CPO Table TBL-30.
FIG. 4.2 illustrates how a Contingent Purchase Order (CPO) Submittal Form web page 4.2(B) is built. The Collaborative Funding Pool (CFP) Name, Number, Minimum Bid and Balance are drawn from the Collaborative Funding Pool Table TBL-20. The text of the ownership terms is drawn from the CFP Ownership Terms Table TBL-10. The text of the payment terms is drawn from the CFP Payment Terms Table TBL-15. The Customer Participant's 20 name, company, Post-To-NUG preference, and Post-To-Participants preferences are drawn from the Participant Table TBL-05.
FIG. 4.3 illustrates how the Under Development page 4.3(B) (optional) is built. All Collaborative Funding Pools (CFPs) with a status of “Accepted” are drawn from the Collaborative Funding Pool Table TBL-20. All Wish records with a Status of “Accepted” are drawn from the Wish Table TBL-35. All Under Development records that don't have a status of “Delivered” are drawn from the Under Development Table TBL-45.
FIG. 4.4 shows various other web pages (Participant Registration web page 4.4(B), Wish Origination web page 4.4(C), Wish Vote web page 4.4(D), and Bug Identification web page 4.4(E)) that each draw data from only one database table.
FIG. 5 illustrates the Participant Registration Process 110. Participants 10 or 20 include individuals who are authorized representatives of the Provider 10 and individuals who are authorized representatives of any of the Provider's Customers 20. The purpose of the Participant Registration Process 110 is to ensure that only authorized individuals enter the database and post data. A Provider 10 that maintains an Enterprise Resource Planning (ERP) system 110(A) can download required data for all Provider Participants 10 as well as all Customer Participants 20 who are included in the Provider ERP system 110(A). Alternatively the Provider 10, at 110(B), and separately, the Customers 20, at 110(C), can enter their authorized Participants data through the Participant Registration web page, at 110(D). Individual Participants 10 or 20 complete the registration process by accessing the Participant Registration web page from their workstation and entering their name, at 110(E). The database checks the Participant Table TBL-05 to determine whether the registering Participant 10 or 20 has been entered as an authorized Participant, at 110(F). If the name is not in the Participant Table TBL-05 the database returns a notice, at 110(G), instructing the Participant 10 or 20 to ask his or her authorized representative to enter his or her name into the Participant Table TBL-05. If the registering Participant 10 or 20 is located in the Participant Table TBL-05 the database requests the Participant 10 or 20 to register a password, at 110(H). Upon entry of the Participant's 10 or 20 chosen password the Engine updates the Participant Table TBL-05, at 110(I), and sends a welcome notice to the Participant 10 or 20, at 110(J).
FIG. 6 illustrates the Collaborative Funding Pool (CFP) Origination Process 210. Any number of types of CFPs can be created depending upon the terms established by the Provider 10 for a given CFP. The origination of a CFP idea, at 210(A), can originate from either the Provider 10 or at a Customer's 20 suggestion. In this presently preferred embodiment only the Provider 10 can create a CFP record, at 210(B). It is obvious to one skilled in the art that other embodiments could permit Customers 20 to create CFPs under controlled circumstances and/or within specified rules. When the Provider 10 elects to create a CFP the Provider 10 enters the CFP Output specifications, at 210(B), and selects CFP Ownership Terms from the CFP Ownership Terms Table TBL-10 and CFP Payment Terms from the CFP Payment Terms Table TBL-15. If the desired ownership and payment terms are not currently available in those tables the Provider 10 must first make those required entries. When the Provider 10 completes the CFP entry the Engine updates the Collaborative Funding Pool Table TBL-20, at 210(C). Appropriate notifications are automatically sent by the Notification Management Module 600 Series to appropriate Participants 10 or 20, at 210(D), and, if appropriate, to the Networked Users Group (NUG) 600(AUX), at 210(E).
FIG. 7 illustrates the Contingent Purchase Order (CPO) Submittal Process 310. When a Customer Participant 20 decides to submit a CPO to a Collaborative Funding Pool (CFP) a registered Customer Participant 20 completes the web page CPO Submittal Form, at 310(A), and submits it. The Engine performs a series of validation tests on the submitted CPO. The Engine asks if the CFP is still open, at 310(B). If it is not, a rejection notice web page is sent to the submitting Customer Participant, at 310(C). If the CFP is still open the Engine checks the submitted CPO's terms against the CFP requirements, at 310(D), such as minimum and fixed bid requirements. If the requirements are not met, a rejection notice web page is sent to the submitting Customer Participant 20, at 310(E). If the CFP requirements are met by the CPO the Engine checks, at 310(F), to see if any Participant from this Customer 20 has previously submitted a successful CPO for this CFP. If a previous CPO was not submitted by this Customer 20, at 310(F), the Engine accepts the CPO and updates the CPO Table TBL-30, at 310(G). If a previous CPO was submitted by this Customer 20 the Engine adds this new CPO amount to the Customer's 20 previous CPO(s) to obtain the Total Customer Submission Value (TCSV), at 310(H). If the TCSV is negative, at 310(I), the Engine rejects the CPO, at 310(3). If the TCSV remains positive the Engine accepts the CPO and updates the CPO Table TBL-30, at 310(G). As is apparent to one skilled in the art, a Provider 10 may elect to refuse negative CPOs, thereby requiring Customers 20 to honor all original CPOs. It is also apparent to one skilled in the art that the validation logic is based on the CFP terms and, therefore, validation algorithms may be different for different types of CFP's.
FIG. 8 illustrates the Collaborative Funding Pool (CFP) Update Process 220. When the Collaborative Funding Engine (the Engine) accepts a Customer Participant 20 Contingent Purchase Order (CPO) it updates the CFP Table TBL-20, at 220(A), by adding the CPO to the CFP record and calculating a new cumulative total for the CFP. The Engine then sends a notice of the accepted CPO to all appropriate Participants 10 or 20, at 220(B). The Engine checks the CFP's cumulative total against the CFP's Hurdle Level, at 220(C). If the Hurdle Level has not yet been reached no further action is taken, at 220(D) If the accepted CPO meets or exceeds the CFP's Hurdle Level the Engine changes the CFP's status to “Accepted”, at 220(E), and notifies all appropriate Participants 10 or 20 of the event, at 220(F). The Engine then checks to see if the CFP payment terms require Customers 20 to make any payment upon acceptance of the CFP, at 220(G). If payments are required of at this time the Engine issues invoices to the appropriate Customers 20, at 220(H). In either case, the Notification Management Module 600 Series notifies the appropriate Provider Participant(s) 10 to commence the CFP project, at 220(I). If no payment is required at this time no invoices are issued.
FIG. 9 illustrates the Collaborative Funding Pool (CFP) Expiration Process 230. Daily the Engine checks the expiration dates of all records in the Collaborative Funding Pool Table TBL-20. In this presently preferred embodiment if the Expiration Date for any given CFP is in 30 days, at 230(A), the Engine sends a 30 Day Expiration Notice to all appropriate Participants 10 or 20, at 230(B). If the expiration date for any given CFP is in three days, at 230(C), the Engine sends a Three Day Expiration Notice to all appropriate Participants, at 230(D). If the expiration date for any given CFP is today, at 230(E), the Engine sends a CFP Expired notice to all appropriate Participants, at 230(F), and changes the CFP status of the CFP to “Closed”, at 230(G). When all CFP Expiration Dates have been checked the process terminates at 230(H). It will be apparent to one skilled in the art that the expiration notification process could be configured to issue any number of notifications triggered by any desired set of relative dates and/or other events.
FIG. 10 illustrates the Collaborative Funding Pool (CFP) Output Delivery Process 240. When the CFP Output is completed and ready for delivery, at 240(A), the appropriate Provider Participant 10 enters the CFP Completion Date and all other appropriate notes into the CFP record, at 240(B), the Engine updates the CFP status to “Completed”, at 240(C), and notifications are sent to appropriate Participants 10 or 20, at 240(D), and, if appropriate, to the Network User Group (NUG) 600(AUX), at 240(E). The Engine notifies the appropriate Provider Participant 10 to deliver the Output to the participating Customers 20, at 240(F), and the Output is delivered, at 240(G). The appropriate Provider Participant 10 enters the “Delivered” date, at 240(H), and the Engine generates appropriate invoices to participating Customers 20, at 240(I).
FIG. 11 illustrates the (optional) Wish Origination Process 410. A Wish is a statement of a desire for a specified new Output. In this Independent Software Vendor (ISV) presently preferred embodiment a Wish may be a requested modification to an existing application, a request for the creation of a new feature within an existing application, a request for the development of an entirely new application, or a request for any number of other Outputs. A Wish may originate from either Provider 10 or Customer 20 Participants, at 410(A), via any variety of communications with the controlling Provider Participant 10 including entry of a Wish request by a Customer Participant 20 on the Provider 10 web site. This powerful feature enables and encourages Customers 20 to readily voice and document their desires for specific new Outputs from the Provider 10, and it enables Provider Participants 10 to put forward new ideas to the Customers 20 to measure the interest in a proposed new Output. The Provider 10 can establish a variety of rules for the Wish when she enters the Wish, at 410(H). For example, the Provider 10 may specify that if a certain Hurdle Number “X” of votes is achieved the Provider 10 will undertake the development of the Output at its own expense. It may establish a lower Hurdle Number “Y” at which, if upon the arrival of a specified Expiration Date, Hurdle Number “X” has not yet been reached the Engine will convert the Wish to a Collaborative Funding Pool (CFP).

In this presently preferred embodiment only authorized Provider Participants 10 may enter a Wish into the Wish Table TBL-35, at 410(B). One can readily imagine embodiments in which Customer Participants 20 can enter Wishes directly into the Wish Table TBL-35.

The Engine then updates the Wish Table TBL-35, at 410(C), and sends notifications to all appropriate Participants 10 or 20, at 410(D), as well as, if appropriate, to the Networked User Group (NUG) 600(aux), at 410(E).

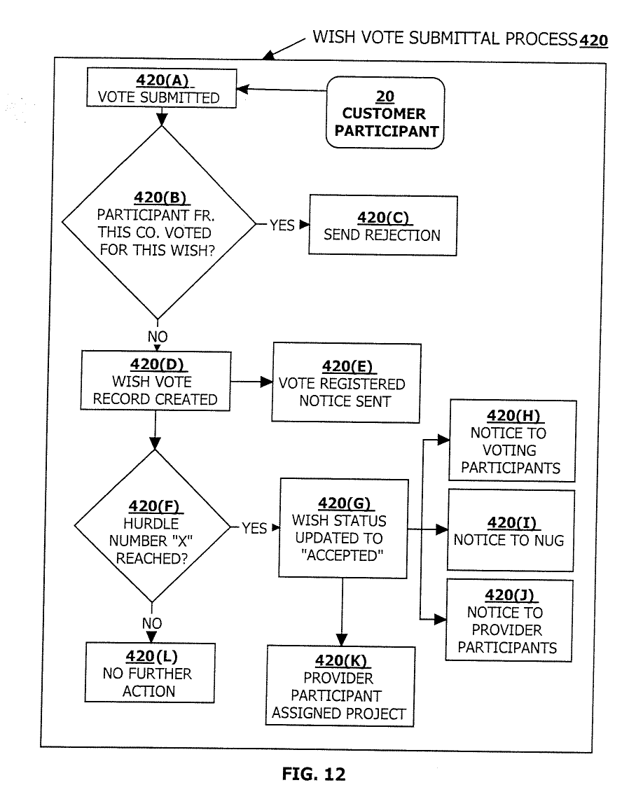

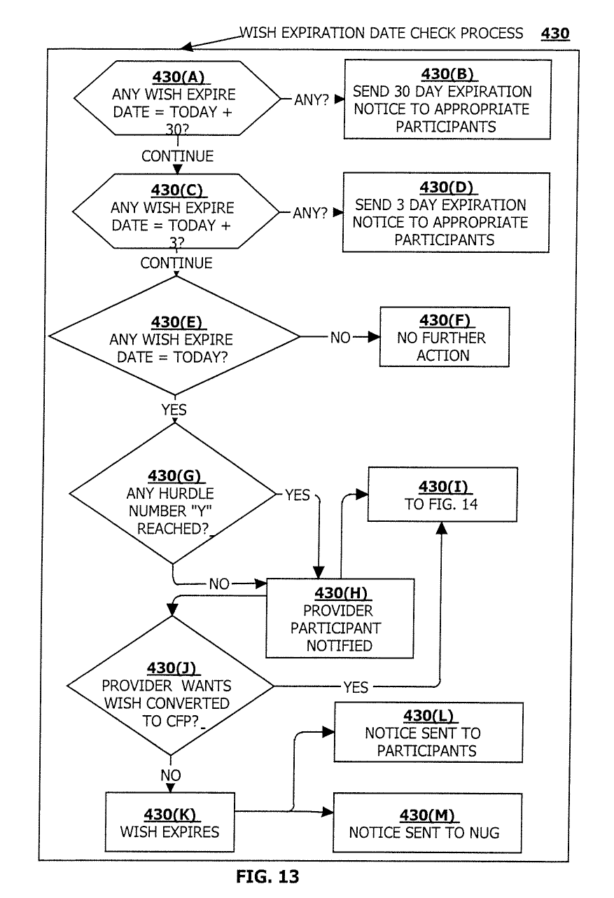

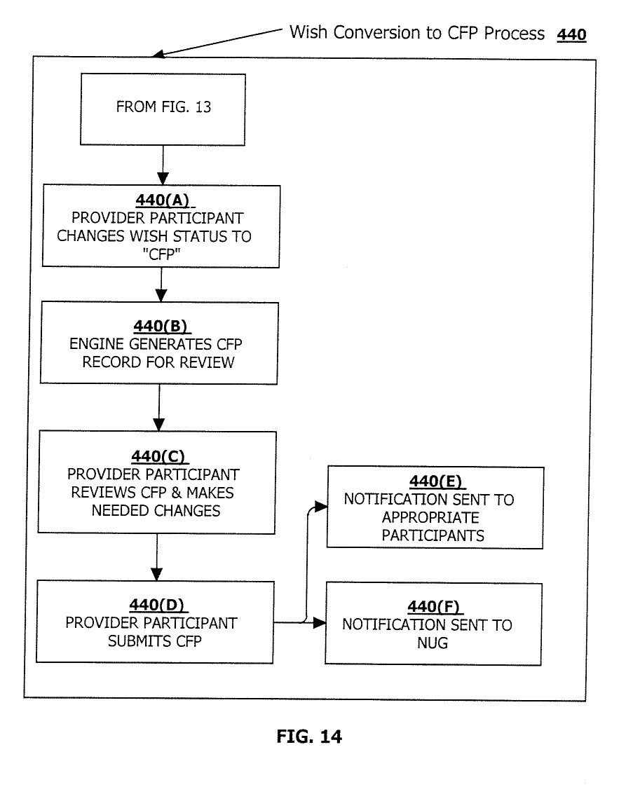

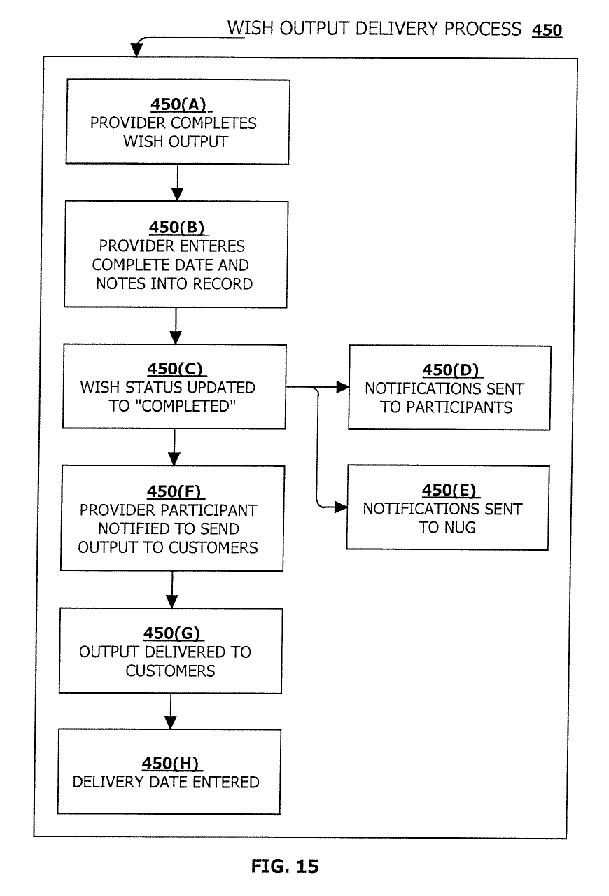

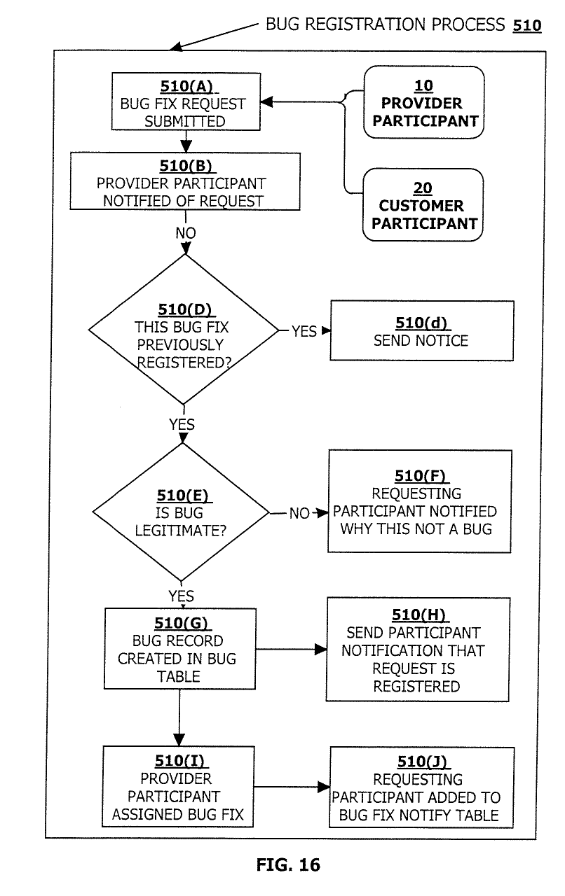

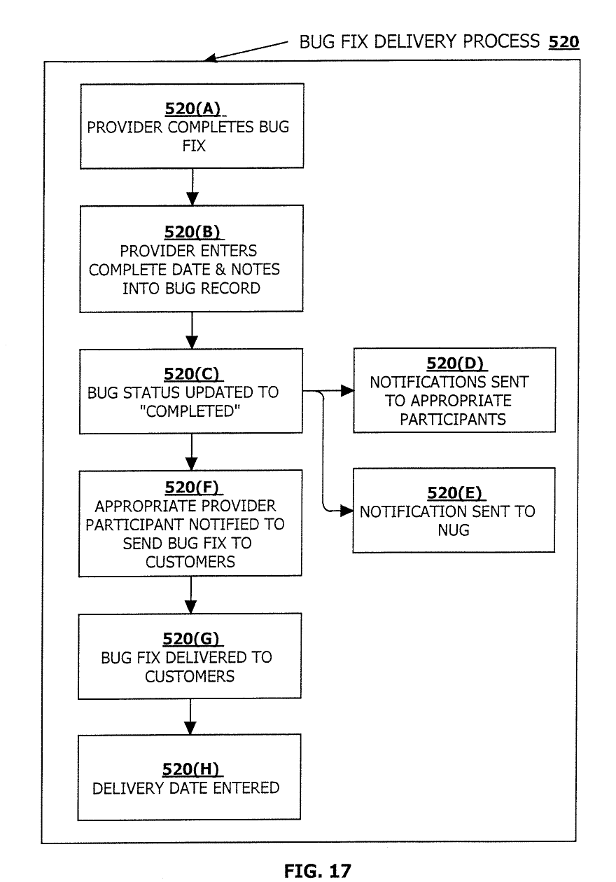

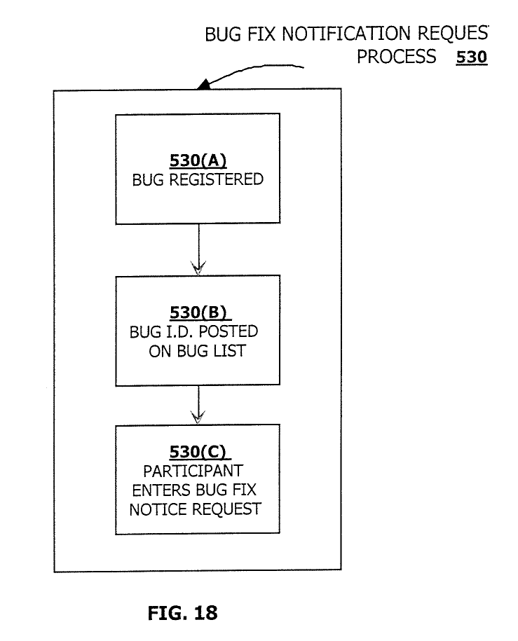

FIG. 12 illustrates the (optional) Wish Vote Submittal Process 420. In this presently preferred embodiment only Customer Participants 20 may cast Wish Votes and only one Vote is accepted for a given Customer 20. The Customer Participant 20 submits a Wish Vote, at 420(A), and the Engine checks to see if another Participant from that Customer 20 has previously voted on this Wish, at 420(B). If a previous vote has been received from this Customer 20 for this Wish, the Engine sends a Vote rejection notice, at 420(C). Otherwise, the Vote is registered in the Wish Vote Table TLB-40, at 420(D), and a notice is sent to the voting Customer Participant 20, at 420(E). The Engine checks to see if the new Vote causes the total Votes to meet the Hurdle Number “X” (see description for FIG. 11, Wish Origination 410), at 420(F). If the Hurdle Number has been reached, the Engine updates the Wish status to “Accepted”, at 420(G), and notifications are sent to all appropriate Participants 10 or 20, at 420(H), the Networked User Group (NUG) 600(AUX), if appropriate, at 420(I), and the appropriate Provider Participants 20, at 420(J). The controlling Provider Participant 10 then assigns the project, at 420(K). If Hurdle Number “X” has not been reached no further action is taken, at 420(L).
FIG. 13 illustrates the (optional) Wish Expiration Date Check Process 430. Once each day the Engine checks the Wish Expiration Date of each Wish in the Wish Table TBL-35. In this presently preferred embodiment if any Wish Expiration Date is in 30 days, at 430(A), the Engine sends a 30 Day notice to all appropriate Participants 10 or 20, at 430(B). If any Wish Expiration Date is in 3 days, at 430(C), the Engine sends a 3 Day notice to all appropriate Participants 10 or 20, at 430(D). If no Wish Expiration Date is today, at 430(E), then no further action is needed, at 430(F). If any Wish Expiration Date is today, at 430(E), the Engine checks the vote count for those Wishes, and if any vote count exceeds Hurdle Number “Y”, at 430(G), (see description for FIG. 11, Wish Origination 410) the Controlling Provider Participant 10 is notified, at 430(H) to convert the Wish to a Collaborative Funding Pool, at 430(I). If Hurdle Number “Y” has not been reached the controlling Provider Participant 10 is notified of the pending Wish Expiration, at 430(H). If the controlling Provider Participant 10 chooses to convert the Wish despite the lack of votes, at 430(J), she makes the conversion, at 430(I) (see FIG. 14). If she chooses not to convert the Wish it expires, at 430(K), and notices are sent to appropriate Participants 10 or 20, at 430(L) and, if appropriate, to the Networked User Group (NUG) 600(aux), at 430(M).
FIG. 14 illustrates the (optional) Wish Conversion to Collaborative Funding Pool (CFP) Process 440. Upon Engine designation of a Wish for conversion to a CFP or the controlling Provider Participant's 10 election to convert (see FIG. 13, 430(I)) the controlling Provider Participant 10 changes the Wish status to “CFP”, at 440(A). The Engine then generates a set of CFP specifications for review, at 440(B), and the Provider Participant 10 reviews the CFP specification and makes any necessary changes to the record, at 440(C). The Provider Participant 10 submits the revised CFP specifications, at 440(D), and the Engine sends notifications to all appropriate Participants 10 or 20, at 440(E) and, if appropriate, to the Network User Group (NUG) 600(AUX), at 440(F).
FIG. 15 illustrates the (optional) Wish Delivery Process 450. When the Wish Output is completed and ready for delivery, at 450(A), the appropriate Provider Participant 10 enters the Wish Completion date and all other appropriate notes into the Wish record, at 450(B), the Engine updates the Wish status to “Completed”, at 450(C), and notifications are sent to all appropriate Participants 10 or 20, at 450(D), and, if appropriate, to the Network User Group (NUG) 600(aux), at 450(E). The Engine notifies the appropriate Provider Participant 10 to deliver the Output to the participating Customers 20, at 450(F), and the Output is delivered, at 450(G). The appropriate Provider Participant 10 enters the “Delivered” date, at 450(H).
FIG. 16 illustrates the (optional) Bug Registration Process 510. Software Bugs may be identified by either Customer 20 or Provider 10 Participants. The identifying Participant 10 or 20 enters a Bug Fix Request, at 510(A). The controlling Provider Participant 10 is notified of the Bug Fix request, at 510(B), and the Provider Participant 10 determines whether the Bug has been previously registered, at 510(C). If the Bug has been previously registered a notice of such is sent to the requesting Participant 10 or 20, at 510(D). If Bug Fix has not previously been requested the Provider Participant 10 determines if the request identifies a legitimate Bug, at 510(E). If the Provider Participant 10 determines that the request does not identify an actual software bug (e.g., the requesting Participant misunderstands system protocol or procedures), the Provider Participant 10 sends an informing notice to the requesting Participant 10 or 20, at 510(F). If it is a legitimate Bug the Provider Participant 10 creates a record in the Bug Table TBL-50, at 510(G), the requesting Participant 10 or 20 is sent a notice that the Bug Fix Request is registered, at 510(H), and a Provider Participant 10 is assigned the Bug Fix, at 510(I). The requesting Participant 10 or 20 is then added to the Bug Notify Table TBL-80, at 510(J).
FIG. 17 illustrates the (optional) Bug Fix Delivery Process 520. When the Bug Fix is completed and ready for delivery, at 520(A), the appropriate Provider Participant 10 enters the Bug Fix Completion Date and all other appropriate notes into the Bug Table TBL-50 record, at 520(B), the Engine updates the Bug record status to “Completed”, at 520(C), and notifications are sent to appropriate Participants 10 or 20, at 520(D), and, if appropriate, to the Network User Group (NUG) 600(aux), at 520(E). The Engine notifies the appropriate Provider Participant 10 to deliver the Bug Fix to the participating Customers 20, at 520(F), and the Bug Fix is delivered, at 520(G). The appropriate Provider Participant 10 enters the “Delivered” date, at 520(H).
FIG. 18 illustrates the (optional) Bug Fix Notification Request Process 530. When a Bug is registered, at 530(A), through the Bug Fix Request process (see FIG. 16, 530(G)) the Bug Identification is posted on the website Bug List, at 530(B). Any Participant may periodically review the Bug List and submit a request to be notified when a specified Bug is fixed, at 530(C).

### Notification Management Module (NMM) 600 Series

Throughout the modules of the presently preferred embodiment described in FIGS. 1 through FIG. 18 are references to notification features, so the Notification Management Module (NMM) 600 Series is not illustrated here separately. The Notification Management Module 600 Series is an interactive community communication module that links Providers 10 and Customers 20 through internet web postings and email notices of appropriate news and inquiries. The NMM links seamlessly with the email systems of both the Provider 10 and the Customer 20, so Participants 10 or 20 can readily send emails to other Participants 10 or 20 (and other interested parties) directly from any Provider 10 web page. As is obvious to one skilled in the art, public communications areas such as message boards and bulletin boards may be established at numerous locations throughout the Engine to stimulate conversations and inquiries that will advance the collaborative features of the Engine. A typical Independent Software Vendor (ISV), as well as many other potential users of this presently preferred embodiment will host or participate in a (optional) Networked Users Group (NUG) 600(aux), which can link readily to the Notification Management Module 600 Series.

Marketing Features of the Notification Management Module 600 Series. The Notification Management Module (NMM) 600 Series can serve as a powerful marketing tool for the Provider 10. Through the NMM 600 Series features, including the various public communications areas, of the Collaborative Funding Pool (CFP) Management Module 200 Series and the (optional) Wish Management Module 400 Series the Provider 10 encourages Customers 20 to express their opinions about and voice their support for product/service enhancements and new developments. This capability creates a powerful platform to nurture so-called “viral marketing.” Viral marketing is the phenomenon where Customers 20 and third parties actively engage in marketing a Provider's 10 products or services at no expense to the Provider 10 through word of mouth. For example, a Customer 20 may submit a Wish for a new application feature, at FIG. 11, because the Customer 20 knows the new feature will significantly enhance their efficiency and effectiveness. Whether the Wish remains on the Wish Table TBL-35 or is converted to a Collaborative Funding Pool, at FIG. 14, it is in the interest of the originating Customer 20 to contact other Customers 20 to promote the proposed Wish Output. In a very meaningful way, such Customer 20 networking and Customer 20 to Customer 20 selling simulates other Customers 20 to pledge Contingent Purchase Orders to Collaborative Funding Pools, at FIG. 7, or to register Wish Votes, at FIG. 12.

The Wish Management Module 400 Series also acts as a continual polling device through which the Provider 10 can float new product/service development ideas by registering them as a Wish, at FIG. 11, to determine if substantial Customer 20 interest in them exists. Furthermore, the Notification Management Module 600 Series informs all Participants 10 or 20 of the creation of new Collaborative Funding Pools (CFPs), at FIG. 6/210(D), Contingent Purchase Orders posted to CFPs, at FIG. 8/220(B), and the addition of new Wishes to the Wish Table TBL-35, at FIG. 11/410(D). A powerful feature of CFPs is that they require Customers 20 to vote for enhancements and new developments by committing funds through a binding Contingent Purchase Order (CPO), at FIG. 7. No more robust method exists in any sales prediction system to determine initial demand for an Output prior to its creation.

Project Management Features of the Notification Management Module 600 Series. For the Provider 10 the Notification Management Module (NMM) 600 Series can serve as an important project management system front end. As the NMM informs appropriate Provider Participants 10 of the formation of Collaborative Funding Pools, at FIG. 6/210(D), and Wishes, at FIG. 11/410(D), as well as the registration of Bugs, at FIG. 16/510(H), the NMM alerts Participants throughout the Provider 10 organization of potential projects on the horizon. Upon the submittal of Contingent Purchase Orders (CPOs), at FIG. 8/220(B), and Wish Votes, at FIG. 12/420(3), the NMM informs appropriate Provider Participants 10 of which development projects are likely to be launched in the near future. Provider Participants 10 not only are alerted to potential new work about to be assigned to them, the NMM also enables such Participants 10 to be informed of interesting new projects that may be launched. Such Participants 10 can then make efforts to be assigned the projects that appeal to them most. As projects are launched the NMM informs all appropriate Provider Participants 10 of who is working on the project, when its delivery is promised, and other pertinent information.

If the Provider 10 establishes “Provider-Only” Wishes (i.e., only Provider Participants 10 can see and vote on the posted Wishes) the Wish Management Module can be an effective way of stimulating collaborative conversations among Provider 10 personnel about the opportunities and constraints of proposed new developments prior to such ideas being presented to the Customers 20.

### DEFINITION OF TERMS

The definitions of the terms used herein are defined as follows:
Application: A software system that provides functional benefit to an organization and has been licensed for use to that organization.
Bug Management Module: An optional module of the invention through which Participants 10 or 20 can view and contribute to a list of known software bugs in a Provider Application. Participants can also request notification when a registered software bug is fixed.
CFP Participant: A registered Customer Participant 20 who has submitted a Contingent Purchase Order (CPO) for a Collaborative Funding Pool (CFP).
Coalition: A specific type of Collaborative Funding Pool (CFP) described here as an example CFP in this presently preferred embodiment. A Coalition has the following attributes:
The submitted Contingent Purchase Orders (CPOs) must all have the same, fixed value. Initial specifications are published.
The benefits are delivered only to the Customers 20 in that Collaborative Funding Pool (CFP). Those benefits of the CFP may be sold to other members of the user community at a later date for a higher price, for example, as an “optional module” of the software application. The Coalition may stay open after the Hurdle Level is reached.
There is a specifications phase that includes input from all Customers 20 in the Coalition, and participating Customers may cancel their Contingent Purchase Orders (CPO) after the final specifications are delivered. If the benefits of the Coalition are packaged and sold as an optional module, the participating module.
   Collaborative Funding Pool (CFP): A mechanism that enables multiple Customers (represented by Customer Participants 20) to submit binding Contingent Purchase Orders (CPOs) to fund the development and or deployment of a functional benefit (an Output).
   Contingent Purchase Order (CPO): A purchase order submitted for a Collaborative Funding Pool (CFP). The CPO is binding on the Provider and the Customer only if the total value of the all CPO's submitted meets or exceeds the Provider specified Hurdle Level of the CFP. Additionally, there may be other optional contingent terms such as date/time (for a Training or Meeting CFP).
   Controlling Participant. A Participant who holds decision-making authority over an aspect of an operation within the Collaborative Funding Engine.
   Customer Participant: An registered individual associated with a Customer 20 who is authorized to take action on behalf of the Customer 20 within the Collaborative Funding Engine.
   Delivery. The transference of a completed Output from a Provider 10 to a Customer 20.
   ERP system: Enterprise Resource Planning System; a software system that manages the broad operations of a corporation.
   Expiration Date: The date by which the Hurdle Level (see below) or Hurdle Number (see below) much be achieved.
   Foreign Key: The field that identifies a record in another table.
   Hurdle Level: The cumulative value of submitted Contingent Purchase Orders (CPOs) within a given Collaborative Funding Pool (CFP) at which point said CFP is moved from “Open” to “Accepted” status. This value must be achieved by the Expiration Date, if posted.
   Hurdle Number The number of Votes required to be cast by authorized Participants 10 or 20 for a given Wish within the Wish Management Module 400 Series upon which the Provider 10 pledges to develop the Wish (feature request) and include it in the Application. This number must be achieved by the Expiration Date, if posted.
   ISV: Independent Software Developer; a company that sells one or more software Applications to a plurality of customers.
   Joint Bid: A specific type of Collaborative Funding Pool (CFP) described here as an example CFP in this presently preferred embodiment. A Joint Bid has the following attributes:
The value of the Contingent Purchase Orders (CPOs) submitted is variable and determined by the Customer Participant. This is known as Relative Value Bidding. (See Definition, Below.)
There is a minimum Contingent Purchase Order (CPO) value published and accepted. For example, for a $2000.00 CFP the minimum bid may be set to $100.00, while for a $50,000.00 CFP the minimum bid may be $2,500.00.
The benefits of the CFP are delivered to all Customers 20, not just the participating Joint Bid Customers 20.
   Key: The unique identifying field of a database record.
   Notification: An automated email message or posted message that notifies a Participant 10 or 20 that a public event has occurred on the Collaborative Funding Engine or that a milestone has been reached. This includes, but is not limited to:
A Collaborative Funding Pool (CFP) has been posted.
A Contingent Purchase Order (CPO) has been submitted.
A Wish has been posted.
A CFP Hurdle Level has been achieved.
The Output from a funded CFP have been incorporated into a version of the application.
CFP funding milestones have been met (for example 800% of the Hurdle Level has been achieved).
The Expiration Date of a CFP or a Wish is approaching or has occurred.
   Notification Management Module: A component of the Collaborative Funding Engine that manages and stimulates Notifications and other communications among Participants 10 or 20.
   NUG: A “Networked User Group.” A group of users that subscribe to an email list that enables them to receive all emails sent by every member of the group.
   Output: Design, research, development, manufacturing, production, publishing, and/or delivery of a new product or service. Including but not limited to:
The design of a new product, and/or
The development of a new product, and/or
The manufacturing of a new product, and/or
The publishing of a new product, and/or
The production of a new product, and/or
The design of a new function for an existing product, and/or
The development of a new function for an existing product, and/or
The design of a new service, and/or
The development of a new service, and/or
The development of a new attribute for an existing service, and/or
The delivery of an existing service at a new date and time, and/or
The delivery of an existing service at a new location.
   Open Source The source code for some computer operating systems and software applications that are made public, allowing third-party developers to modify them.
   Participant: An authorized individual associated with either a Provider 10 or a Customer 20 who may initiate or observe activity on the Collaborative Funding Engine.
   Posting: A publishing of data in a viewable form on a communications network.
   Private CFP: A Collaborative Funding Pool (CFP) in which all Contingent Purchase Order (CPO) submission information is not made available to all Customer Participants 20 of the CFP. Typically, only the number of CPOs and the Total Value Bid is published.
   Public CFP: A Collaborative Funding Pool (CFP) in which all Participants 10 or 20 can view the Customer Participant 20 Name, Customer Participant 20 Company, and CPO Amount of all CPOs submitted. The Notification activity described in this presently preferred embodiment assumes Public CFPs.
   Public Communications Areas: Locations on a network on which individuals may post comments or other data, which can be accessed by other individuals on the network and, typically, which encourages and facilitates responding comments, e.g., message boards and bulletin boards.
   Provider: The company that develops and sells the Application and/or other Outputs offered.
   Provider Participant: An authorized representative of the Provider 10 who may initiate activity within the Collaborative Funding Engine and receive notifications of Collaborative Funding Engine events.
   Relative Value Bidding: An optional feature of the invention that permits and encourages different Customer Participants to submit Contingent Purchase Orders (CPOs) for a given Collaborative Funding Pool (CFP) that specify varying prices for identical Outputs, Collaborative funding tests have shown that organizations are willing to contribute varying amounts of money to receive the same benefits under the same terms and conditions as other participating organizations when each organization is allowed to voluntarily determine it's own level of contribution to the CFP.
   Royalties: Rights to a specified percentage of income from the sale or licensing of an Output.
   Rules of Ownership: Terms of a Collaborative Funding Pool (CFP) that specify ownership rights of Provider 10 and Customers 20 and how royalties, if specified, from the sale or licensing of the Output are allocated.
   Rules of Payment: Terms of a Collaborative Funding Pool (CFP) that specify when Customers 20 are required to pay amounts specified in Contingent Purchase Orders (CPOs).
   Specification: A detailed description of an Output which may include but is not limited to text, graphics, drawings, video, and sound.
   Subscribing Participant: A Participant 10 or 20 who has registered to receive all notifications concerning all Collaborative Funding Pools (CFPs) and Wishes.
   Votes: A formal expression of interest by a registered Participant in a defined Wish within the (optional) Wish Management Module 400 Series.
   Wish: A formal statement of the specifications of a desired Output within the Wish Management Module 400 Series.
   Wish Management Module: An optional component system of the Collaborative Funding Engine through which Participants 10 or 20 can request potential new Outputs (the Wish) and other Participants 10 or 20 can register their desire for said Output by casting Votes for the Wish. The Provider 10 may specify a required number of Wish Votes (the Hurdle Number) upon receipt of which the Provider 10 will develop the requested Output provided the Hurdle Number is reached prior to the Expiration Date specified by the Provider 10. Within the Wish Management Module 400 Series a Provider 10 may elect at any time to convert a Wish to a Collaborative Funding Pool (CFP).
   Wish Participant: A Participant 10 or 20 who has voted for a Wish within the Wish Management Module.

### Other Potential Applications

While the invention has been specifically described in a presently preferred embodiment for the Independent Software Vendor (ISV) industry, the Collaborative Funding Engine (the Engine) can also provide great benefits to an array of other enterprises, as discussed below. It will be obvious to one skilled in the art that the wider array of potential applications described below may likely include some or all of the following potential embellishments to the Engine:
A specification and terms negotiation system could be linked to the Engine that would enable Providers 10 and Customers 20 to propose and negotiate changes to the specifications and terms of a Collaborative Funding Pool (CFP) during the CFP's life.
The Engine could be modified to accommodate a plurality of Providers 10 who collaborate to create an Output for one or a plurality of Customers 20.
The Engine could be modified to accept Collaborative Funding Pool (CFP) Output proposals put forward by one or a plurality of Customers 20 to solicit offers by one or a plurality of Providers 10 to create the Output.
A Participant 10 or 20 evaluation system could be added to evaluate and publish the qualifications and credit worthiness of Providers 10 and Customers 20.

Other applications of the Collaborative Funding Engine include but are not limited to:

### Other Software Development

The presently preferred embodiment described above enables an Independent Software Vendor to engage its existing clients to help fund improvements to its software application(s). The Engine can also be used very effectively to develop software within other Provider 10/Customer 20 environments.

For example, many smaller software and hardware companies with limited development resources but preferred technologies are in fierce competition with dominant competitors with large development resources. Such smaller competitors could utilize the Engine not only to generate funding from their Customers for in-house development; they could also utilize the invention to recruit outside developers to collaborate with an array of Customers (not just those of the smaller competitor) to develop new applications for their preferred technologies.

For example, a computer company we will call “Challenger” offers an open source office productivity application that bundles word processing and spreadsheet software together to compete with the most popular commercial package offered by a company we will call “Dominant”. Although Challenger's software is free of charge, most companies still purchase Dominant's software because it is perceived to offer more features and be more robust and because many fear that Challenger may not survive its competition with Dominant. At the same time, many Dominant users would welcome the opportunity to switch to a viable alternative that is less expensive and that stimulates greater competition within this market segment. Challenger, by itself, does not have the development resources to make its software a viable competitor to Dominant's. Challenger, however, could create a website utilizing the Collaborative Funding Engine that is dedicated to it office productivity software development. Third party developers (Providers 10) throughout the world could post a wide variety of proposed Challenger software enhancements as Collaborative Funding Pools, and current and/or potential Challenger Customers 20 could commit development funds in the form of Contingent Purchase Orders for desired enhancements. Challenger could use its limited development resources to manage the specification oversight and other project coordination issues, and soon the Collaborative Funding Engine (stimulated by the Notifications Management Module 600 Series) could transform Challenger's free office software into a serious competitor of Dominant's, thereby, transforming the competitive landscape of the application software market.

Another beneficial example would be an “open source code” website driven by the Engine that would attract large quantities of development resources to fuel the development of open source applications. Open source code means that no proprietary programming fundamental to the operations of the software is kept secret and hidden from its users. Most commercial software developers keep this foundation software hidden from users to maintain proprietary control of the software. The advantage that many find with open source code software is that an array of software developers throughout the world are, thereby, able to develop new software that operates on a foundation of, or in concert with, the open source code program. This environment encourages the development of powerful and creative public domain software. Large numbers of computer users, including many large corporations, favor the use and growth of open source code software over much of the proprietary software that now dominates and controls many software markets. However, in general, the proprietary software vendors have a greater economic incentive and more financial resources to apply to the development of their products. The Collaborative Funding Engine can level that the playing field between open source and proprietary products by enabling disparate groups of companies and individuals who want the benefit of open source software to pool their resources to promote the development of these products.

Yet another software development embodiment of the Engine would be for use on websites promoted to developing application plug-ins and application utilities. Plug-ins are generally smaller products that work with larger products. Utilities are small programs that enhance an operating system.

### Training Sessions and Conferences

Skills training that involves one or more instructors interactively teaching a body of students in real time is a large industry. This industry offers training sessions from a large number of training companies for nearly every imaginable skill whether it be computer software, accounting, or management skills, cooking, photography, or language skills, or any of thousands of other training sessions now commercially available. Although traditionally such skills training has been conducted at a physical location with students and teachers in the same room, many real-time training sessions are now conducted over the internet, through telephone conference calls, or with interactive television.

Regardless of the venue, the commercial success of all training sessions comprised of an instructor in an interactive, real-time relationship with a group of students is dependent upon enrolling an adequate number of students whose cumulative fees cover all costs and, hopefully, generate a surplus. Financial success is largely dependent upon the training company's ability to accurately predict the demand for the specified training session at an announced location, time, and price. Long term success includes developing a reputation for reliability, so the training company must avoid canceling announced classes even if enrollment falls short of covering the costs. Accurately predicting the level of skill training in demand and the optimal time, place, and price that will attract the requisite number of students is especially difficult for more esoteric skills, more advanced levels of training, and locations with smaller populations.

The Collaborative Funding Engine can significantly benefit this industry. For example, various computer software training companies provide training sessions for the leading page-layout software. Some of the sessions are for beginners, some for intermediate skills, and some for advanced skills. The larger training companies hold sessions for these various skill levels in most of the large cities in the U.S. at various times of the year. The longevity of these training programs suggests that the training companies have developed a methodology to predict demand for each given session well enough to realize a company-wide profit. Almost certainly, however, the companies are passing by opportunities to host additional profitable classes because it is too risky to predict demand for them, especially as noted above, for more esoteric skills, more advanced levels of training, and locations with smaller populations. In addition, the students who desire these training that are not offered miss the opportunity to advance their skills, and the professionalism of the companies that employ these potential students (and that often pay for such students' training) is held back by the lack of available training.

By employing the Engine training companies could propose a much broader array of training sessions with Collaborative Funding Pool (CFP) Expiration Dates that would allow the company adequate time to reserve space and schedule instructors if the CFP Hurdle Level is reached. The “viral marketing” feature of the Notification Management System would encourage students who submit Contingent Purchase Orders (CPOs) for a given session to network among friends and associates with a similar interest to recruit other students to submit CPO so the CFP can reach its Hurdle Level. The training company would profitably fill more classes, and more students would receive the training that they desire.

The advantages would be the same for companies and individuals who host conferences.

The advantage to these industries of utilizing the Collaborative Funding Engine is even greater when the optional Relative Value Bidding feature is employed. For example, a national training company may offer a limited number of introductory page-layout training sessions in a small mid-western city. The company's demand prediction methodology as well as past experience may tell them that, for example, adequate demand for an advanced training session with an attendance price of, say, $195 for a day-long session does not exist in this small city. The company may need, say, 25 students or total fees of $4875 for this class to generate the desired profit, and past experience has never suggested that a demand of that level exists in this city. A growing, profitable book publisher may, however, be located in this small city that is very desirous of advanced page-layout training for its production staff of ten people. The lack of availability of such training in their city is limiting the productivity growth of the publishing company. The publishing company may be willing to pay $350 for each of its 10 employees for the training. At the same time, there may be 15 other individuals in the city who would happily pay $100 each for the training but would not be able to afford the normal $195 price.

The training company could make a Collaborative Funding Pool with Relative Value Bidding available on its website for this training session in this city with a cumulative Hurdle Level of $4875, a minimum bid of, say $100, and an Expiration Date of, say, February 15^{th}. When the publishing company learns of this opportunity it could enter a Contingent Purchase Order of $3500 for 10 seats. The publishing company could then begin networking through email and phone calls to inform all of its free-lance page-layout contractors as well as other smaller book and magazine publishers in town. Here's a chance, they would say to other potential students, to get advanced training for only $100. We simply need to find 15 individuals willing to pay that reduced price, and we can all get the advanced training that we desire. The 15 individuals are recruited through no effort of the training company, the Hurdle Level is reached, the training is given, and the training company realizes its needed profit. The Collaborative Funding Engine would have brought benefit to everyone involved, a benefit that could not have been realized without the invention.

Once use of the Engine is established and understood, Customers would likely suggest training CFP proposals to the training company with a significant number of students recruited in advance. The invention could significantly accelerate the growth of the training company enterprise.

### Universal Internet Project Site

Having considered the benefits that the Collaborative Funding Engine could bring to the software development and the training and conference industries it is not difficult to see that the Engine could also be beneficially utilized by a large number of other industries. More such industry candidates are discussed in some detail below. As one more fully comes to understand the broad scope of applicability of the Engine it becomes apparent that an internet developer could construct a universal internet site driven by the invention that accepts qualified Providers 10 and Customers 20 from any industry or interest group. Such a Universal Collaborative Funding Engine site could be segmented, for example, into industry types or general subject matter. Within a given industry type qualified Providers 10 and Customers 20 could post Collaborative Funding Pools (CFPs) that propose specified Outputs and then utilize the Notification Management System to recruit the needed Providers 10 or Customers 20 to bring the CFP to the Hurdle Level. Anyone skilled in the art can recognize that other controlling systems may need to be linked to the present invention to make such an Universal Collaborative Funding Engine site viable, but such other controlling systems either already exist or could be developed. As mentioned above, a Participant Evaluation Module and Negotiation Management Module would be important supporting components in the Universal Collaborative Funding Engine site.

### Provider Originated Example

For example, a specialty cook stove manufacturer might design a new cook stove with a revolutionary new feature. It may be that the manufacture's rate of new product development does not warrant an in-house Collaborative Funding Engine website. Informal polling of the manufacturer's established wholesale accounts may suggest a potential initial demand for only about 1500 stoves at the suggested retail price. The manufacture's calculations, however, may tell her that she could not break even in the production of the new stove without initial orders of at least 2500. After completing the registration and qualification entry procedure, the manufacturer could register on the Kitchen and Cuisine section of the Universal Collaborative Funding Engine site and enter a Collaborative Funding Pool (CFP) that proposes the specifications of the stove. The CFP may specify that the unit wholesale price is, say, $1950 for Contingent Purchase Orders (CPOs) of five stoves or more and, say, $1495 for CPOs of 20 stoves or more and that the Hurdle Level is cumulative orders of 2500 stoves. Once the CFP is posted the manufacturer would contact, by various means, all of her established customers as well as her list of potential customers and industry and consumer media outlets. Assisted by the Notification Management Module of the Universal Collaborative Funding Engine site, word of the potential new product would spread throughout the cooking interest community. Individuals would urge retailers to order the stove and eager retailers would urge other retailers to submit CPOs for the CFP in order to achieve the Hurdle Level. Eventually, the Hurdle Level would be reached prior to the CFP Expiration Date, or if not, the manufacturer would be saved the costs of a failed new product launch.

### Customer Originated Example

Another example of a potential use for a Universal Collaborative Funding Engine website could consist of a enthusiast automobile club whose members all own sports cars of a certain manufacturer. If the club has a website the members likely exchange ideas and comments frequently on the club's message boards and bulletin boards. A member with a convertible model may read about a new fabric that is widely used in the outdoor equipment industry, and this member may believe that a convertible top made of this new fabric might prove more durable and bring other benefits lacking in the auto manufacture's original convertible top. After further examination and perhaps conversations with the fabric manufacturer and an aftermarket convertible top manufacturer, the member and a growing number of other club members may decide to attempt to bring about the creation of this new top through the Universal Collaborative Funding Engine website.

After completing the registration and qualification entry procedure, the participating club members could enter a Customer originated Collaborative Funding Pool (CFP) in the automotive aftermarket segment of the Universal Collaborative Funding Engine site that states initial specifications and includes Contingent Purchase Orders (CPOs) from, say, 2300 club members who are eager and willing to acquire the new convertible top at a price of up to, say, $4500. Once the CFP is posted the club members would utilize the Notification Management Module to inform all Provider and Customer Participants registered in this segment. The club would also likely contact the club newsletter and all other automobile media to promote the benefits of this new product idea and to stimulate interest among both potential Providers and Customers.

Eventually, conversations would arise between potential Providers and the club members and specifications, retail price, and the Hurdle Level may be altered through negotiations (using either conventional means or with the assistance of an attached Negotiations Management Module). If one or more Providers eventually agree to sponsor one or more Collaborative Funding Pools (CFPs) with given specifications, prices, and Hurdle Levels the enthusiasts use all means available to recruit adequate Customer Contingent Purchase Orders (CPOs) to reach the Hurdle Level. Otherwise the new product idea is set aside.

Once well developed and fully established a Universal Collaborative Funding Engine website could revolutionize the way new products and services are developed and substantially reduce the costs of new product/service failures.

### Research Projects

Whether through a Universal Collaborative Funding Engine website or an in-house implementation, the Engine could bring significant benefits to the research industry. Many well-established companies and innumerable individuals provide original research to interested companies and individuals throughout the world. Corporate research firms provide extensive off-the-shelf reports that can be purchased for a fixed price. Research companies and individuals will also provide custom research for a negotiated price depending upon the cost of the research and its perceived value.

Throughout the business world, government entities, universities, and among individual entrepreneurs and scholars a very large demand exists for custom research. Much of this demand goes unmet because of the cost of the research. The Collaborative Funding Engine could be utilized to generate funding for much of this unsatisfied research demand.

For example, a chronic and growing water shortage exists in northern New Mexico. Various parties have conducted studies of the problem and have produced projections about water supply into the next century. But these studies are limited and their findings unreliable because no one party has been able to fund research of the scope needed to produce convincing results. City and county governments need reliable, in-depth research. The critically important hotel and restaurant industry wants to know the water facts. Residential developers believe that ample long-term water supplies exist. Anxious governing bodies enact construction moratoriums to preserve the water supply, but they cannot produce convincing research. Environmental groups sound alarms but lack convincing scientific research to support their claims. Business development groups attempt to recruit manufacturers to open new facilities in the area, but candidates hold back because of the uncertainty of the sustainable water supply. Hydrologist, environmental, and business professors at state and private universities are all eager to learn the facts. Everyone involved in this debate needs better and more reliable research on the long-term water supply for New Mexico, but no one party to this debate can afford to fund a large scale in-depth study by top researchers. So everyone muddles along with inferior information.

A research firm, or the University of New Mexico, or Santa Fe County, or the State of New Mexico could employ the Collaborative Funding Engine to create a Collaborative Funding Pool (CFP) with clearly defined research specifications and Relative Value Bidding to finance this much desired and very expensive study. The sponsor could find a qualified research team, establish a Hurdle Level needed to fund the study, and launch a networked marketing campaign with the Notification Management Module. It is likely that cumulative Contingent Purchase Orders (CPOs) from all the interested parties, employing Relative Value Bidding, could fund the study and, thereby, move the conversation from speculative debate toward consensus.

Yet another example of using the Collaborative Funding Engine for research would be to expand the market for individual research companies. These companies are typically hired by individual organizations to do research on a specific topic, and then publish the results to be used by those organizations. The research companies may also do research “on spec” and then try to sell that research to other organizations. Through the use of the Collaborative Funding Engine, research firms will be able to propose projects on their websites, and companies and individuals will be able to submit Contingent Purchase Orders (CPOs) to fund them. Thus, the research firm will be able to expand sales with a lower risk than when projects are done “on spec”.

### Travel Industry

In recent years, various companies have developed computerized methods that manage fractional ownership or “time-sharing” of private jet airplanes. These methods typically require that companies or individuals sign up for a minimum number of flight hours per year. These services are generally used by highly affluent organizations and individuals. An airline, however, could employ the Collaborative Funding Engine to make private jet travel available to a much larger number of people and organizations. Through the use of Collaborative Funding Pools (CFPs), airline Providers could post an array of tentative schedules, with the understanding that each trip will take place only if the Hurdle Level is reached by the specified Expiration Date. This would make occasional booking of seats on small private jets available to a much larger population and stimulate significant growth in this business segment.

The Collaborative Funding Engine could also greatly benefit adventure and excursion travel companies. They could post a large number of potential group tours and/or excursions (including many outings that they would otherwise hesitate to propose because of perceived low demand) and allow the Customer demand to decide which trips will be held during the following year. By permitting Customer proposed CFPs special interest groups could reveal unsuspected demand for unique guided travel excursions and recruit fellow travelers at no expense to the excursion company.

The present invention would provide a similar benefit to the cruise vacation industry.

### Wide Application of the Collaborative Funding Engine

This short list of potential other applications described above includes merely a few examples of the wide potential application of the Collaborative Funding Engine. One skilled in the art could extend this list of potential applications to hundreds of other environments.

### Table Specifications

Participant Table Specifications [TBL-05]

| [Participant] Field Name | Type | Length | Indexed | Description |
|---|---|---|---|---|
| Customer_ID | Long Integer | | ✓ | This is the Customer key field from |
| | | | | the ERP system. |
| Customer_Name | Alpha | 80 | ✓ | This is the Customer Name from the |
| | | | | ERP system. If ERP synchronization |
| | | | | is not used, this is the Customer |
| | | | | Name submitted when the |
| | | | | Participant registered. |
| Contact_ID | Long Integer | | ✓ | This is the Contact (Participant) key |
| | | | | field from the ERP system. |
| Contact_Name | Alpha | 60 | ✓ | This is the Contact Name from the |
| | | | | ERP system. If ERP synchronization |
| | | | | is not used, this is the Name |
| | | | | submitted when the Participant |
| | | | | registered |
| eMailAddress | Alpha | 80 | ✓ | EMail address of the Participant. |
| ID | Long Integer | | ✓ | The unique key of the record. |
| Mail_InFromParticipants | Boolean | | | Notification Preference: The |
| | | | | Participant wants to receive CPO |
| | | | | Submittal Notification for all CFPs. If |
| | | | | this is false, they will only receive |
| | | | | notifications for pools they are |
| | | | | participating in. |
| Mail_OutToNUG | Boolean | | | Notification Preference: By default |
| | | | | the Participant wants their CPO |
| | | | | Submittals to be posted to the NUG. |
| | | | | This can be changed on the CPO |
| | | | | Submittal form. |
| Mail_OutToParticipants | Boolean | | | Notification Preference: By default |
| | | | | the Participant wants their CPO |
| | | | | Submittals to be posted to all |
| | | | | Participants who have registered to |
| | | | | receive all notifications. This can be |
| | | | | changed on the CPO Submittal form. |
| Note | Text | | | This is a comment about the |
| | | | | Participant entered by the Provider |
| | | | | and visible only to the Provider. |
| Password | Alpha | 12 | | The secret code that verifies that the |
| | | | | Participant is valid. |
| CFP_Provider_Default | Boolean | | | The Provider Participant who will be |
| | | | | assigned to every newly created |
| | | | | CFP. |
| Provider | Boolean | | ✓ | Signifies that the Participant works |
| | | | | for the Provider company. |
| User_Group | Boolean | | | Signifies that this Participant is |
| | | | | actually a group on a list server. For |
| | | | | example the Provider's NUG. |
| Wish_Provider_Default | Boolean | | | The Provider Participant who will be |
| | | | | assigned to every newly created |
| | | | | Wish. |

CFP-Ownership Table Specifications [TBL-10]

| [Ownership] Field Name | Type | Length | Indexed | Description |
|---|---|---|---|---|
| ID | Long Integer | | ✓ | The unique key of the record. |
| Ownership_Type | Alpha | 30 | | The descriptive record |
| | | | | identification. For example: |
| | | | | Standard Joint Bid |
| | | | | Standard Coalition |
| | | | | Coalition With Royalty |
| Terms | Text | | | Description of the ownership terms. |
| | | | | For example: |
| | | | | The modification becomes part of |
| | | | | the application Core System and all |
| | | | | clients have access to the |
| | | | | functionality. |

CFP-Payment Terms Table Specifications [TBL-15]

| [Payment_Terms] Field Name | Type | Length | Indexed | Description |
|---|---|---|---|---|
| ID | Long Integer | | ✓ | The unique key of the record. |
| Payment_Terms_Name | Alpha | 30 | | The descriptive record identification. |
| | | | | For example: |
| | | | | Standard Joint Bid |
| | | | | Standard Coalition |
| | | | | Prepaid |
| | | | | Deposit |
| Terms | Text | | | Description of the payment terms. |
| | | | | For example: |
| | | | | Net 10 Days after receipt of bill. |
| | | | | Project is not billed until the version |
| | | | | containing the new feature has been |
| | | | | shipped to you. |

Collaborative Funding Pool (CFP) Table Specifications [TBL-20]

| [CFP] Field Name | Type | Length | Indexed | Description |
|---|---|---|---|---|
| Area | Alpha | 30 | ✓ | Area of the application. For example: |
| | | | | Invoice\|Credit Memo\|Vendor |
| Date_Closed | Date | | | The date the CFP closed. A CFP may close |
| | | | | because the Price has been met or the Price |
| | | | | has not been met and the Expiration Date has |
| | | | | passed. |
| Date_Delivered | Date | | | The date the feature funded by the CFP was |
| | | | | included in a version of the application. |
| Date_Entered | Date | | | The date the CFP was created. |
| Date_Expect_Delivery | Date | | | If the Price is met the CFP is closed and this |
| | | | | date is automatically assigned based on the |
| | | | | Date_Closed plus the Days_To_Complete. |
| Date_Expiration | Date | | | The date after which if the Price is not met, |
| | | | | the CFP expires. The CFP is marked closed, |
| | | | | and all submitted CPO's for that CFP are |
| | | | | canceled by the system. |
| Date_Posted | Date | | | The date the CFP first appears on the |
| | | | | Sponsor's website. |
| Days_To_Complete | Integer | | | The estimated number of days the project |
| | | | | being funded by the CFP is expected to take. |
| | | | | Not relevant for some CFPs, such as certain |
| | | | | kind of trainings and meetings. |
| Function | Alpha | 20 | ✓ | Description of the application aspect. For |
| | | | | example: |
| | | | | Process\|Report\|Form |
| ID | Long Integer | | ✓ | The unique key of the record. |
| Minimum_Bid | Real | | | The minimum CPO value accepted. |
| Module | Alpha | 30 | ✓ | Module that the project belongs to. For |
| | | | | example: |
| | | | | Order Entry\|AP\|GL\|Inventory |
| Name | Alpha | 60 | ✓ | The descriptive name of the CFP. |
| Num_Bids | Long Integer | | | The number of CPO's submitted. This field is |
| | | | | updated by the CPO table trigger. |
| Origination_Info | Text | | | Text describing the origin of the CFP. For |
| | | | | example, a feature request email submitted by |
| | | | | a customer. |
| Ownership_ID | Long Integer | | ✓ | The Foreign Key linking an Ownership record |
| | | | | to the CFP. This is used to publish the |
| | | | | ownership terms of the completed CFP. |
| Payment_Terms_ID | Long Integer | | ✓ | The Foreign Key linking an Payment_Terms |
| | | | | record to the CFP. This is used to publish the |
| | | | | payment terms of the completed CFP |
| CFP_Type | Alpha | 20 | | The type of CFP: |
| | | | | Joint Bid\|Coalition\|Training\|Meeting\| |
| | | | | Research Report |
| Post_To_Web | Boolean | | ✓ | Designates that the Provider wants to display |
| | | | | this CFP on the website. |
| Price | Real | | | That value the must be met in order for the |
| | | | | CFP to be accepted. |
| Private | Boolean | | | Designates that the CPO information |
| | | | | should not be displayed on the website. |
| | | | | This means that Participants will not |
| | | | | know who has submitted the CPO's. |
| Specification_Detail | Text | | | Detailed text specifications of the CFP. |
| Specification_Doc_Path | Text | | | A pathname specifying the location of a |
| | | | | document that contains detailed |
| | | | | specifications. Used when text |
| | | | | specifications in the Specification_Detail |
| | | | | are not adequate for communicating the |
| | | | | complete detail. |
| Specification_Summary | Text | | | A short text description of the CFP. |
| Status | Alpha | 20 | | Joint Bid example: |
| | | | | Open\|Accepted\|Delivered\|Expired |
| TotalValueBid | Real | | | The total value of all CPO's submitted for |
| | | | | the CFP. This field is updated by the |
| | | | | CPO table trigger. |
| Version_Delivered | Alpha | 20 | | The version the feature funded by the |
| | | | | CFP was first included in the application. |

CFP-Schedule Table Specifications [TBL-25]

| [CFP_Schedule] | | | | |
|---|---|---|---|---|
| Field Name | Type | Length | Indexed | Description |
| Duration | Time | | | Length of the meeting or |
| | | | | training. |
| ID | Long | | ✓ | The unique key of the |
| | Integer | | | record. |
| CFP_Date | Date | | | Date of the meeting |
| | | | | or training. |
| CFP_ID | Long | | ✓ | Foreign Key field |
| | Integer | | | linking this record to |
| | | | | the CFP table. |
| Start_Time | Time | | | Starting Time of the |
| | | | | meeting or training. |

Contingent Purchase Order (CPO) Table Specifications [TBL-30]

| [CPO] Field Name | Type | Length | Indexed | Description |
|---|---|---|---|---|
| Amount | Real | | | The financial value of the CPO submitted. |
| Comment | Text | | | An optional message entered by the |
| | | | | submitting Participant. The Participant |
| | | | | uses this to build support by others in the |
| | | | | community for this project. This is |
| | | | | sometimes referred to as “viral marketing”. |
| Date_Submitted | Date | | | The date the CPO was submitted. |
| Documentation | Text | | | Stores CPO documentation (for example, |
| | | | | original email) if the CPO was not |
| | | | | submitted by web-form. |
| ID | Long Integer | | ✓ | The unique key of the record. |
| Mail_OutToNUG | Boolean | | | Boolean setting that determines whether a |
| | | | | notification about this CPO will be sent to |
| | | | | the NUG. When the web CPO form is |
| | | | | presented to the Participant, this value is |
| | | | | assigned based on the default value |
| | | | | chosen by the Participant in his/her |
| | | | | account maintenance form which is stored |
| | | | | in the Participant table. |
| Mail_OutToParticipants | Boolean | | | Although CPO notifications are always sent |
| | | | | to other CDP Participants, this Boolean |
| | | | | setting determines whether a notification |
| | | | | about this CPO will be sent to all |
| | | | | Subscribing Participants. CPO form is |
| | | | | presented to the Participant, this value is |
| | | | | assigned based on the default value |
| | | | | chosen by the Participant in his/her |
| | | | | account maintenance form which is stored |
| | | | | in the Participant table. |
| Participant_ID | Long Integer | | ✓ | Foreign Key field linking this record to the |
| | | | | Participant table. |
| PONumber | Alpha | 20 | | An optional purchase order number |
| | | | | entered by the submitting Participant. |
| CFP_ID | Long Integer | | ✓ | Foreign Key field linking this record to the |
| | | | | CFP table. |
| Submit_Method | Alpha | 20 | | The method by which the CPO was |
| | | | | submitted. Most CPO's will be submitted |
| | | | | by a web-form. |
| | | | | Web\|Fax\|eMail\|Mail |
| Terms_Text | Alpha | 50 | | The payment and ownership terms posted |
| | | | | for this CFP at the time of the submission. |
| | | | | These terms are displayed on the CPO |
| | | | | web-form. |
| Time_Submitted | Time | | | Time CPO was submitted. |
| Digital Signature | Blob | | | Optional digital authorization. |

Wish Table Specifications [TBL-35]

| [Wish] Field Name | Type | Length | Indexed | Description |
|---|---|---|---|---|
| Area | Alpha | 30 | ✓ | Area of the application. For example: |
| | | | | Invoice\|Credit Memo\|Vendor |
| Date_Closed | Date | | | Date the Wish Closed. A Wish closes when it |
| | | | | expires, the hurdle level is met, it is manually |
| | | | | closed by the Provider, or it is moved into a CDE, |
| | | | | usually a Joint Bid. |
| Date_Delivered | Date | | | Date that the feature was included in the |
| | | | | Application. |
| Date_Entered | Date | | | Date the Wish was entered into the database. |
| Date_Expiration | Date | | | Date the Wish expired because the Hurdle |
| | | | | Number was not met. |
| Date_Posted | Date | | | Date the Wish was first posted to the Web-site. |
| Function | Alpha | 20 | ✓ | Description of the application aspect. For |
| | | | | example: |
| | | | | Process\|Report\|Form |
| ID | Long Integer | | ✓ | The unique key of the record. |
| Implementation_Plan | Text | | | In some cases an Accepted Wish may be not be |
| | | | | included in the Application for a reasonably long |
| | | | | period of time from when it was first accepted. |
| | | | | For example, if it can only be included within the |
| | | | | context of developing a larger feature. When this |
| | | | | is the case, an Implementation Plan will be |
| | | | | entered so Participants can be apprised of the |
| | | | | process and circumstance for developing the |
| | | | | Wish feature. |
| Module | Alpha | 30 | ✓ | Module that the project belongs to. For example: |
| | | | | Order Entry\|AP\|GL\|Inventory |
| Name | Alpha | 60 | ✓ | Name of the Wish. A short description. |
| Num_Votes | Long Integer | | | Number of votes submitted for the Wish to date. |
| Origination_Info | Text | | | Information about the origination of the Wish. |
| | | | | For example, could be a copy of an email |
| | | | | message sent by a user participant to the |
| | | | | Provider. |
| Post_To_Web | Boolean | | ✓ | Specifies that the Wish should be posted to the |
| | | | | Web-site. |
| Projected_Delivery | Alpha | 20 | | String representation of the projected month the |
| | | | | Wish feature will be included in the application. |
| | | | | For example, December 2002. Entered manually by |
| | | | | Provider Participant when a Wish is accepted. |
| Specification_Detail | Text | | | Detailed description of the Wish feature. |
| Specification_Summary | Text | | | Short description of the Wish feature. |
| Status | Alpha | 20 | ✓ | The Status of the Wish: |
| | | | | Accepted\|Delivered\|Expired\|Joint Bid\|Open |
| Version_Delivered | Alpha | 20 | | The version number of the Application that the |
| | | | | Wish feature was first included in. |
| Wish_Hurdle_Date | Date | | ✓ | Hurdle Date. The date by which the Hurdle |
| | | | | Number of votes must be reached. |
| Wish_Hurdle_Num | Long Integer | | | Hurdle Number. The number of votes needed for |
| | | | | the Provider to include in the application. |
| | | | | (Accepted) |

Wish-Vote Table Specifications [TBL-40]

| [Vote] Field Name | Type | Length | Indexed | Description |
|---|---|---|---|---|
| Comment | Text | | | An optional note included with the Vote that |
| | | | | allows the Participant to communicate why they |
| | | | | voted. |
| Date_Submitted | Date | | | Date the Vote was submitted. |
| ID | Long Integer | | ✓ | The unique key of the record. |
| Participant_ID | Long Integer | | ✓ | Foreign Key field linking this record to the |
| | | | | Participant table. Identifies which Participant |
| | | | | submitted the Vote. |
| Submit_Method | Alpha | 20 | | How the Vote was submitted. Usually from web- |
| | | | | site but the following methods are possible: |
| | | | | Web\|Mail\|Phone\|eMail\|Fax |
| Wish_ID | Long Integer | | ✓ | Foreign Key field linking this record to the Wish |
| | | | | table. |

Under-Development Table Specifications [TBL-45]

| [Under_Development] Field Name | Type | Length | Indexed | Description |
|---|---|---|---|---|
| Area | Alpha | 30 | ✓ | Area of the application. For |
| | | | | example: |
| | | | | Invoice\|Credit Memo\|Vendor |
| Completion_Date | Date | | | Date of Completion |
| Date_Entered | Date | | | Date entered into database. |
| Date_Posted | Date | | | Date posted to web |
| Expected_Delivery | Alpha | 20 | | Month/Year of expected to be |
| | | | | included in a version of the |
| | | | | Application. |
| Function | Alpha | 20 | ✓ | Description of the application aspect. |
| | | | | For example: |
| | | | | Process\|Report\|Form |
| ID | Long Integer | | ✓ | The unique key of the record. |
| Module | Alpha | 20 | ✓ | Module that the project belongs to. |
| | | | | For example: |
| | | | | Order Entry\|AP\|GL\|Inventory |
| Specification_Detail | Text | | | Detailed description of the project. |
| Specification_Doc_Path | Text | | | If there is a specification document, |
| | | | | the document path of where it is |
| | | | | stored. |
| Specification_Summary | Text | | | Summary description of the project. |
| Status | Alpha | 30 | ✓ | Status of the project: |
| | | | | Delivered\|Being Researched\| |
| | | | | In Private Beta\|In Public Beta\| |
| | | | | Specification Development\| |
| | | | | Under Development |
| Version_Delivered | Alpha | 20 | | Version the function first included in |
| | | | | the Application. |
| Date_Delivered | Date | | ✓ | Date the function first included in |
| | | | | the Application. |

Bug Table Specifications [TBL-50]

| [Bug] Field Name | Type | Length | Indexed | Description |
|---|---|---|---|---|
| Area | Alpha | 30 | ✓ | Area of the application. For example: |
| | | | | Invoice\|Credit Memo\|Vendor |
| Date_Entered | Date | | | Date the bug was recorded in the database. |
| Date_Fixed | Date | | | Date the bug was fixed. |
| Date_Posted | Date | | | Date the bug was posted to the web-site. |
| Description | Text | | | Detailed description of the bug. |
| Function | Alpha | 20 | ✓ | Description of the application aspect. For |
| | | | | example: |
| | | | | Process\|Report\|Form |
| ID | Long Integer | | ✓ | The unique key of the record. |
| Module | Alpha | 30 | ✓ | Module that the project belongs to. For |
| | | | | example: |
| | | | | Order Entry\|AP\|GL\|Inventory |
| Num_Notify_Requests | Long Integer | | | Number of Bug Fix Notification Requests |
| | | | | submitted for this Bug. |
| Post_To_Web | Boolean | | | Specifies that the Wish should be posted to |
| | | | | the Web-site. |
| ReportedBy_Participant_ID | Long Integer | | | Foreign Key field linking this record to the |
| | | | | Participant table. Identifies which Participant |
| | | | | submitted the bug. |
| Summary | Text | | | Short description of the bug. |
| Version_Fixed | Alpha | 20 | | Version the bug was fixed. |
| Workaround | Text | | | Description of a temporary way to avoid the |
| | | | | problems caused by the bug, if possible. |

Notification-Templates Table Specifications [TBL-55]

| [Notification_Participant] | | | | |
|---|---|---|---|---|
| Field Name | Type | Length | Indexed | Description |
| Instructions | Text | | | Explains when |
| | | | | and how each |
| | | | | record is used. |
| Message | Text | | | The template |
| | | | | data. |
| Notification_Type | Alpha | 20 | ✓ | The unique key |
| | | | | of the record. |
| | | | | Descriptive as |
| | | | | well. |

Notification-Types Record Examples [TBL-55 (aux)]

| Diagram | Type | Description |
|---|---|---|
| CFP Origination | New CFP | Sent to Participants when a new CFP is posted to |
| | | the website. |
| CFP Origination | New CFP NUG | Sent to the Nug when a new CFP is posted to |
| | | the website. |
| CPO Web-Form | CPO Confirmation | Sent to the CPO Submitter to confirm receipt of |
| Submittal Process | | CPO. |
| CPO Web-Form | CPO Submittal | Sent to all Subscribing Participants when a CPO |
| Submittal Process | | has been submitted. |
| CPO Web-Form | CPO Submittal CFP | Sent to all CFP Participants when a CPO has |
| Submittal Process | | been submitted. |
| CPO Web-Form | CPO Submittal NUG | Sent to the NUG when a CPO has been |
| Submittal Process | | submitted. |
| CFP Delivered Process | CFP Delivered | Sent to all Subscribing Participants when the |
| | | benefits of a CFP are made available. |
| CFP Delivered Process | CFP Delivered CFP | Sent to all CFP Participants when the benefits of |
| | | a CFP are made available. |
| CFP Delivered Process | CFP Delivered NUG | Sent to the NUG when the benefits of a CFP are |
| | | made available. |
| Wish Origination | Wish Posted | Sent to all Subscribing Participants when a new |
| Process | | Wish has been posted on the website. |
| Wish Origination | Wish Posted NUG | Sent to the NUG when a new Wish has been |
| Process | | posted on the website. |
| Vote Submittal | Wish Accepted | Sent to Wish Participants when a Wish is |
| | | accepted (Hurdle Level met). |
| Vote Submittal | Wish Accepted NUG | Sent to the NUG when a Wish is accepted |
| | | (Hurdle Level met). |
| Vote Submittal | Wish Accepted Provider | Sent to Wish Provider Participants when a Wish |
| | | is accepted (Hurdle Level met). |
| Wish Delivered Process | Wish Delivered | Sent to Wish Participants when a Wish is |
| | | delivered (included in shipping version of |
| | | Application). |
| Wish Delivered Process | Wish Delivered NUG | Sent to the NUG when a Wish is delivered |
| | | (included in shipping version of Application). |
| Wish Expiration Process | Wish Expire 30 | Sent to all Subscribing Participants and NUG |
| | | when a Wish is 30 days from expiring. |
| Wish Expiration Process | Wish Expire 3 | Sent to all Subscribing Participants and NUG |
| | | when a Wish is 3 days from expiring. |
| Wish Expiration Process | Wish Expired | Sent to all Subscribing Participants and NUG |
| | | when a Wish has expired. |
| Wish Conversion To | Wish ConvertJB | Sent to all Subscribing Participants when a Wish |
| Joint Bid ™ Process | | is converted into a Joint Bid ™. |
| Wish Conversion To | Wish ConvertJB Wish | Sent to all Wish Participants when a Wish is |
| Joint Bid ™ Process | | converted into a Joint Bid ™. |
| Wish Conversion To | Wish ConvertJB NUG | Sent to the NUG when a Wish is converted into a |
| Joint Bid ™ Process | | Joint Bid ™. |
| Bug Fix Notification | Bug Fix Notify Confirm | Sent to the Bug Fix Notification Request |
| Request | | submitter when the database has recorded their |
| | | request. |
| Bug Fix Delivered | Bug Fixed Delivered | Sent to the Bug Fix Notification Request |
| | | submitters when the fix is included in shipping |
| | | version of Application. |
| Registration Process | Registration Welcome | Sent to a Participant who has successfully |
| | | registered. |

THIS IS NOT A DATABASE TABLE, but rather a list and brief description of common Notification Types included in the Notification Templates Table TBL-55. The list is sorted by diagram reference.

Notifications-Sent Table Specifications [TBL-60]

| [Notification] Field Name | Type | Length | Indexed | Description |
|---|---|---|---|---|
| Bug_ID | Long Integer | | ✓ | Foreign Key field linking this record to the |
| | | | | Bug table. |
| Date_Sent | Date | | | Date the notification was sent. |
| ID | Long Integer | | ✓ | The unique key of the record. |
| Notification_Text | Text | | | Text of the notification. |
| Notification_Type | Alpha | 20 | ✓ | Foreign Key field linking this record to the |
| | | | | Notification_Type table. Also classifies |
| | | | | the type of notification sent. |
| Pool_ID | Long Integer | | ✓ | Foreign Key field linking this record to the |
| | | | | Pool table. |
| Time_Sent | Time | | | Time Notification was sent |
| Wish_ID | Long Integer | | ✓ | Foreign Key field linking this record to the |
| | | | | Wish table. |

Notifications-To Table Specification [TBL-65]

| [Notification_Participant] | | | | |
|---|---|---|---|---|
| Field Name | Type | Length | Indexed | Description |
| Notification_ID | Long | | ✓ | Foreign Key |
| | Integer | | | field linking |
| | | | | this record to |
| | | | | the Notification |
| | | | | table. |
| Participant_ID | Long | | ✓ | Foreign Key |
| | Integer | | | field linking |
| | | | | this record to |
| | | | | the Participant |
| | | | | table. |
| eMailAddress | Alpha | 80 | | EMail address |
| | | | | the notification |
| | | | | was sent to. |

CFP-Provider-Notify Table Specifications [TBL-70]

| [CFP_Provider_Notify] | | | | |
|---|---|---|---|---|
| Field Name | Type | Length | Indexed | Description |
| ID | Long | | ✓ | The unique key |
| | Integer | | | of the record. |
| Participant_ID | Long | | ✓ | Foreign Key |
| | Integer | | | field linking |
| | | | | this record to the |
| | | | | Participant table. |
| CFP_ID | Long | | ✓ | Foreign Key field |
| | Integer | | | linking this record |
| | | | | to the CFP table. |

Wish-Provider-Notify Table Specifications [TBL-75]

| [Wish_Provider_Notify] | | | | |
|---|---|---|---|---|
| Field Name | Type | Length | Indexed | Description |
| ID | Long | | ✓ | The unique key |
| | Integer | | | of the record. |
| Participant_ID | Long | | ✓ | Foreign Key |
| | Integer | | | field linking this |
| | | | | record to the |
| | | | | Participant table. |
| Wish_ID | Long | | ✓ | Foreign Key |
| | Integer | | | field linking this |
| | | | | record to the |
| | | | | Wish table. |

Bug-Notify Table Specifications [TBL-80]

| [Bug_Notify] Field Name | Type | Length | Indexed | Description |
|---|---|---|---|---|
| Bug_ID | Text | | | Foreign Key field linking this record |
| | | | | to the Bug table. Identifies which |
| | | | | Bug the Participant wishes to be |
| | | | | informed about. |
| Date_Submitted | Date | | | Date the Bug Notification Request |
| | | | | was submitted. |
| ID | Long Integer | | ✓ | The unique key of the record. |
| Participant_ID | Long Integer | | ✓ | Foreign Key field linking this record |
| | | | | to the Participant table. Identifies |
| | | | | which Participant submitted the |
| | | | | Bug Notification Request. |

1. A method for collaboratively funding output over a communications network comprising:
a. defining the output by means of a specification where the output is at least one of a product or service that does not currently exist;
b. establishing a predetermined hurdle level, which is a threshold, required by a provider participant to supply the output in accordance with said specifications;
c. establishing one or more terms for funding and supplying the output;
d. creating a “collaborative funding pool” by posting said specification, the hurdle level, and one or more terms on the communications network accessible to customer participants who may have at least one of an interest in purchasing the output or owning royalty or residual rights to the providing of said output and who may be willing to contribute monetary or other resources to fund the delivery of the output;
e. receiving binding contingent customer commitments from one or more of the customer participants who agree to participate in said collaborative funding pool, each contingent customer commitment constituting a binding offer to contribute resources toward the delivery of said output should the hurdle level be achieved or exceeded; and
f. binding said provider participant to supply the output according to the specification and at least one of the terms and binding all participating customer participants to make their defined contribution to the pool if the hurdle level is be achieved or exceeded.

2. The method of claim 1, wherein said output includes at least one of: the design of a new product, the development of a new product, the design of a new function for an existing product, the development of a new function for an existing product, the production of a new product, the design of a new service, the development of a new service, the development of a new attribute for an existing service, the delivery of an existing service at a new date and time, the delivery of an existing service in a new location, the delivery of an existing product under new terms and conditions, the delivery of an existing service under new terms and conditions.

3. The method of claim 1, wherein said output comprises at least one of the following: software application, research report, online training session, physical location training session, online meeting, physical location meeting, infrastructure development.

4. The method of claim 1, wherein said terms specify one of the following: a fixed contingent customer contribution commitment, a variable contingent customer contribution commitment, or a customer-determined contingent contribution commitment.

5. The method of claim 4, wherein a minimum value is set for said contingent customer-determined contribution by said provider participant.

6. The method of claim 5 whereby said contingent customer commitment is rejected if said minimum value is not met.

7. The method of claim 1, wherein said terms include rules of payment.

8. The method of claim 1, wherein said terms include rules of ownership of the output.

9. The method of claim 8, wherein said rules of ownership include a customer participant's receipt of royalty or residual rights.

10. The method of claim 1, wherein said contingent customer commitment is rejected if the hurdle level has previously been met.

11. The method of claim 1, wherein said contingent customer commitment is accepted even though the hurdle level has previously been met.

12. The method of claim 1, wherein the total value submitted of said collaborative funding pool is updated if said contingent customer commitment is successfully submitted.

13. The method of claim 12, wherein said collaborative funding pool is accepted as fully funded if the total value submitted meets or exceeds the hurdle level.

14.-15. (canceled)

16. The method of claim 1, wherein said participants are notified when a contingent customer commitment is successfully submitted.

17. The method of claim 1, wherein sad selected information pertaining to the status of said collaborative funding pool is made available to at least one of the pool participants or potential pool participants.

18. (canceled)

19. The method of claim 1, wherein the identity of the customer participant is verified prior to participating in said collaborative funding pool.

20. The method of claim 19, wherein the identity of the customer participant is verified through the use of a digital signature.

21. The method of claim 1, wherein the specifications for said collaborative funding pool are developed by a plurality of participants on the communications network.

22. (canceled)

23. The method of claim 21, wherein said mechanism includes a “wish list” consisting of a list of wishes for potential outputs of future collaborative funding pools.

24. The method of claim 23, wherein each said wish can be voted upon by customer participants.

25. The method of claim 23, wherein a vote hurdle number is established for each said wish to determine if the wish is accepted and implemented to modify the specification.

26. The method of claim 23, wherein said wish is converted into a collaborative funding pool when said hurdle number is reached.

27. The method of claim 23, wherein the provider participant can convert said wish into a collaborative funding pool before the hurdle number is reached.

28. The method of claim 1, wherein the specification for said collaborative funding pool is developed by a provider participant, by one or a plurality of customer participants, or by a collaboration between the provider participant and the customer participants.

29.-31. (canceled)

32. The apparatus for collaboratively funding output over a communications network comprising:
a. means for defining the output by means of a specification;
b. means for establishing a predetermined hurdle level, which is a threshold, required by a provider participant to supply the output in accordance with said specifications;
c. means for establishing one or more terms for funding and supplying the output;
d. means for creating a “collaborative funding pool” by posting the specification, the hurdle level and one or more terms on the communications network accessible to customer participants who may have at least one of an interest in purchasing the output or owning royalty or residual rights to the providing of said output and who may be willing to contribute monetary or other resources to fund the delivery of the output;
e. means for receiving binding contingent customer commitments from one or more of the customer participants who agree to participate in said collaborative funding pool, each contingent customer commitment constituting a binding offer to contribute resources toward the delivery of said output should the hurdle level be achieved or exceeded; and
f. means for binding said provider participant to supply the output according to the stated specification and at least one of the terms and binding all participating customer participants to make their defined contribution to the pool if the hurdle level is be achieved or exceeded.

33. The apparatus of claim 32 comprising means for specifying at least one of: the design of a new product, the development of a new product, the design of a new function for an existing product, the development of a new function for an existing product, the production of a new product, the design of a new service, the development of a new service, the development of a new attribute for an existing service, the delivery of an existing service at a new date and time, the delivery of an existing service in a new location, the delivery of an existing product under new terms and conditions, the delivery of an existing service under new terms and conditions.

34. The apparatus of claim 32 comprising means for specifying one of the following: a fixed contingent customer contribution commitment, a variable contingent customer contribution commitment, or a customer-determined contingent contribution commitment.

35. The apparatus of claim 32 comprising means for specifying rules of ownership of the output.

36. The apparatus of claim 35 comprising means for specifying and managing a customer participant's receipt of royalty or residual rights.

37. The apparatus of claim 32 comprising means for notifying participants when a contingent customer commitment is successfully submitted.

38. The apparatus of claim 32 comprising means for making available selected information pertaining to the status of said collaborative finding pool to at least one of the pool participants or potential pool participants.

39. The apparatus of claim 32 comprising means for allowing the specifications for said collaborative funding pool to be developed by a plurality of participants on the communications network.

40. The apparatus of claim 32 comprising means for allowing the specifications for said collaborative funding pool to be developed by a provider participant, by one or a plurality of customer participants, or by a collaboration between the provider participant and the customer participants.
